(19) United States
(12) Patent Application Publication
(10) Pub. No.: US 2007/0168302 A1
(43) Pub. Date: Jul. 19, 2007

(54) Retirement plan advisory system

(75) Inventors: Vincent J. Giovinazzo, Laguna Hills, CA (US); Jeffrey S. Elvander, Costa Mesa, CA (US)

Correspondence Address: MICHAUD-DUFFY GROUP LLP, 306 INDUSTRIAL PARK ROAD, SUITE 206, MIDDLETOWN, CT, 06457, US

(73) Assignee: 401(k) Advisors, Inc., Aliso Viejo, CA (US)

(21) Appl. No.: 11/527,098

(22) Filed: Sep. 25, 2006

Related U.S. Application Data
(60) Provisional application No. 60/760,201, filed on Jan. 19, 2006.

(51) Int. Cl. G06Q 40/00

(52) U.S. Cl. 705/36 R

(57) ABSTRACT

A method is provided for advisory assistance from an advisor to a fiduciary for qualified retirement plan selection and investment due diligence. The method includes evaluating products and services offered by a plurality of plan providers, reviewing reports provided by the advisor and selecting a plan. In one embodiment, the evaluation includes an analysis of components of each of the products by identifying the components of the plan and providing a measure of the plan provider's style box coverage and best asset class offering across multiple style box categories. The method includes generating a statement outlining a process for selecting, monitoring and evaluating investment options, determining a score for the plan providers' investments based on specific quantitative and qualitative factors, generating reports comparing the investment options within their corresponding products and vetting the selected investment options within a current plan.

### CROSS-REFERENCE TO RELATED APPLICATIONS

This patent application claims benefit under 35 U.S.C. §119(e) of copending, U.S. Provisional Patent Application, Ser. No. 60/760,201, filed Jan. 19, 2006, the disclosure of which is incorporated by reference herein in its entirety.

### COPYRIGHT NOTICE

A portion of the disclosure of this patent document contains material that is subject to copyright protection. The copyright owner has no objection to the facsimile reproduction by anyone of the patent document or the patent disclosure, as it appears in the U.S. Patent and Trademark Office patent files or records, but otherwise reserves all copyright rights whatsoever.

### BACKGROUND OF THE INVENTION

1. Field of the Invention

This invention relates generally to the field of financial advisory services and, more particularly, to systems and methods for advising fiduciaries in the selection, monitoring and compliance of a qualified retirement plan and its corresponding investment options among a set of available qualified retirement products and a sub-set of their corresponding investment options.

2. Description of the Related Art

Until the early 1980s, defined benefit plans were the dominant form of retirement income plans sponsored by corporations for their employees. Under defined benefit plans, employees who separate from service receive retirement benefits that are insured by the Pension Benefit Guaranty Corporation (PBGC), a federal corporation created by the Employee Retirement Income Security Act (ERISA) of 1974, as amended. The employer's ongoing contribution to the plan is determined actuarially. Since 1974 and the enactment of ERISA, there have been a number of legislative acts impacting qualified pension and profit sharing plans. One legislative act, codified under U.S. Internal Revenue Code, Section 401(k), was devised to encourage workers to set aside money for their retirement years by allowing them to defer paying taxes on “retirement money” placed in a qualified plan until retirement, at which time they would likely be in a lower tax bracket and, therefore, pay less total tax on the dollars. These retirement plans, e.g., so called 401(k) plans, can be structured several ways and can optionally be either a profit sharing plan or an employer stock ownership plan (ESOP) plan. The 401(k) plan permits employees to contribute an allowable percentage of pretax income into the plan, making them a very attractive long-term savings vehicle for retirement. Most 401(k) plans provide an employer matching contribution of some kind and allow employees to be pro-active in selecting the investment direction of their accounts. A heightened awareness by employees of relevant market factors has tended to increase the popularity of the 401(k) benefit plan and other qualified retirement plans that have similar characteristics such as, e.g., 403(b) and 457 plans.

As can be appreciated the legislative acts, while designed to encourage retirement savings and protect employers, employees and retirement savings, have introduced a labyrinth of complex rules, accounting procedures, investment options, testing, compliance requirements, technology services, and reporting schemes. Generally, every qualified retirement plan requires knowledgeable monitoring to ensure it stays in compliance with regulations promulgated by the Internal Revenue Service (IRS) and Department of Labor (DOL). As such, selection and management of a qualified retirement plan from the wide array of plan providers to the number of diverse investment options is often difficult for even the most financially sophisticated persons and businesses. Accordingly, most prudent business persons retain the services of professional consultants and plan providers to setup, operate, test, monitor and otherwise supervise the overall retirement plan established for a group of individual employees.

A number of systems and methods exist in the prior that are designed to collect, organize and evaluate financial data to improve the quality and value of an investment while also reducing risk. Software systems exist that may be used by portfolio managers, advisors and individual investors that assist in developing investment strategies. For example, U.S. Pending Patent Application Publication No. 2002/0007332 of Johnson et al. describes a system and method for comparing financial products as funding sources for a financial plan, such as a non-qualified supplemental benefit plan or an individual financial plan. Johnson et al. describe selecting two or more financial products for comparison in accordance with a set of attributes (e.g., financial strength of a company, funding analysis, contractual features, etc.), assigning a weight to each of the attributes, scaling the values of the financial products across each attribute, multiplying the scaled values by the assigned weights, and generating a weighted score for each financial product by summing the weighted scaled values for each product. The resulting scores are said to allow a user to differentiate among various product offerings.

U.S. Pending Patent Application Publication No. 2005/0144110 of Chen et al. describes an automated retirement plan manager that manages assets of an employee retirement benefits plan on behalf of an employer. The plan manager executes trades on investment vehicles based on instructions from an automated, independent investment advisor. The advisor calculates a “human capital” (e.g., present value of future labor income or the actuarial present value of future savings directed toward retirement saving in the contexts of retirement portfolio management) for each plan participant based on data derived from the employer and from the participant through an interface, and based on that human capital calculation recommends an allocation of portfolio assets to the participant. Once reviewed and perhaps modified by the participant, the recommendation becomes an instruction to the plan manager. As the participant ages his or her human capital is recalculated, again considering variables such as future labor income, the amount of retirement savings in qualified retirement vehicles (such as 401(k) and IRA plans) and nonqualified retirement vehicles (such as taxable accounts and variable annuities), current age, retirement age, mortality and life expectancy, gender, real long-term interest rate, defined benefit pension income if any and social security income. The recalculated human capital is then used to determine whether the participant's present portfolio type should now be switched to a more conservative one.

U.S. Pending Patent Application Publication No. 2005/0038725 of Boyle et al. describes a method for selecting a portfolio of securities for investment purposes and deciding the quantity of shares of each selected security that that are included in the portfolio. More particularly, the method comprises providing an investment portfolio including selected securities from selected economic sectors; weighting the selected economic sectors to provide a sector weight for each selected economic sector; weighting selected securities to provide an intra sector weight for each selected security; weighting a selected security according to its intra sector weight, the sector weight of the selected security's economic sector and a predetermined percentage to provide a dependent weight of a selected security; determining an equal-weighted weight of a selected security according to the sector weight of the selected security's economic sector, the predetermined percentage and the number of securities selected from that economic sector; and adding a selected security's dependent weight to its equal-weighted weight to yield a portfolio weight of that selected security.

U.S. Pending Patent Application Publication No. 2005/0038725 of Charnley et al. describes a process to audit the performance of investment professionals in carrying out the responsibilities involved in managing the investment performance of an investment portfolio. Charnley et al. claim that their process is unique from existing processes that evaluate investment manager performance in that its evaluative methodologies conform to the minimum standards required of an audit process in that the evaluative findings are complete, unbiased and consistent over time. The findings derived from the method are said to be complete because they include the review of four specific selection functions critical for sustaining relative portfolio performance over time and generate an explicit evaluation of each of these four functions. The findings derived from the method are said to be unbiased and consistent because they measure manager performance relative to whole-population samples of managers engaged in the same functional activities over multiple market periods. Existing systems benchmark manager performance against securities-market indices or narrow samples of investment manager populations, which have been shown in use to generate biased and inconsistent measurements as market conditions change. Charnley et al. state that the capability to produce an evaluation of investment manager performance of audit quality arises from the insight that functions involved in selecting an investment portfolio can only be evaluated from the perspective of benchmarks generated from complete populations of alternative selection strategies if such an evaluation is to be complete, unbiased and consistent over time.

A number of prior art software systems have been designed incorporating the above described and other methods for evaluating financial instruments of interest to a user. These prior art systems assist users, to varying degrees, in assessing the quality, value, and risk of such instruments in which the user may wish to invest. In order for the software systems to be practically useful, they must generally be designed to efficiently collect, organize, and evaluate vast amounts of financial and other types of data that are retrieved from multiple data providers and from other data sources. The data may then be processed according to a specific model or methodology to evaluate the financial instrument for future investment.

For example, U.S. Pat. No. 6,317,726 describes a method of implementing investment strategies to facilitate the selection of corporate stocks for investment. A number of value factors are considered in the assessment of strategies, which may include price-to-earnings ratios, price-to-book ratios, cash flow ratios, price-to-sales ratios, and dividend yields. Strategies can then be evaluated using the Sharpe ratio. U.S. Pat. No. 6,211,880 discloses an apparatus for displaying trends in the prices of financial instruments such as stocks. A display is dedicated to a specific sector of the market and appears rectangular with individual boxes, where each box represents an individual stock. A color is assigned to each box, representing the degree of fractional deviation of the most recent trading price of the corresponding stock from an assigned selected reference value, such as the price at the end of a previous trading session.

It should be appreciated from the above discussion that professional consultants may use a variety of tools to assist in the collection, organization and evaluation of financial data pertinent to financial instruments and products. However, the inventors have identified a number of perceived deficiencies in many of these tools when applied to all aspects of a qualified retirement plan; including the monitoring, selection, and performance of products offered by vendor(s) and the underlying investment options included therein. For example, many of these tools focus only on the performance of individual and/or a selected group of financial instruments and do not consider the performance of one or more entities that provide services to those persons investing in the instruments. That is, the prior art systems and methods are not seen to consider and offer an objective analysis (e.g., with set parameters) of all obligations fiduciaries need to consider when evaluating and selecting investment options within a qualified retirement plan.

Accordingly, the inventors have realized that there remains a need for systems and methods for advising fiduciaries providing retirement benefit plans to participants as it relates to regulations promulgated by governmental agencies, for example, ERISA, Section 404(a). More particularly, the inventors have developed systems and methods for evaluating, selecting and monitoring one or more qualified retirement plans and their corresponding investment offerings to be offered to participants for retirement savings and like investments, such systems and methods considering not only performance characteristics of subject financial instruments but also evaluating performance of entities providing such instruments to meet obligations fiduciaries have to participants of a retirement plan.

### SUMMARY OF THE INVENTION

The present invention is directed to a method for providing advisory assistance from an advisor to a fiduciary for qualified retirement plan selection and investment due diligence. The method includes evaluating a plurality of products and services offered by a plurality of plan providers, and reviewing reports provided by the advisor and selecting a plan. In one embodiment, the evaluation of the plurality of products and services includes an analysis of components of each of the products by identifying the components of each of the plurality of products including plan administration, record keeping, plan compliance to regulatory mandates, investment management, technology services, communication to plan participants, total cost of the plan, and an average score for each of the plurality of plan provider's investment offerings that measures the plan provider's style box coverage and best asset class offering across, for example, twelve style box categories. The method also includes generating a statement outlining a process for selecting, monitoring and evaluating investment options, wherein a score is created for the chosen plan provider's investments based on performance, style characteristics, peer group rankings and other analysis, generating reports and scores comparing the investment options within their corresponding product and vetting the selected investment options within their current plan.

In one embodiment, the reports and scores comparing the products and investment options within a corresponding product is provided by means of a secured website available on a global communications network such as, for example, the Internet, intranet or extranet.

### BRIEF DESCRIPTION OF THE DRAWINGS

The features and advantages of the present invention will be better understood when the Detailed Description of the Preferred Embodiments given below is considered in conjunction with the figures provided.

FIG. 1 is a simplified block diagram illustrating a retirement plan advisory system configured and operating in accordance with one embodiment of the present invention.

FIG. 2 is a simplified block diagram illustrating an evaluation process within the retirement plan advisory system of FIG. 1.

FIG. 3 illustrates one embodiment of a Scorecard^{SM} Report for providing a measure of the relative performance, characteristics, behavior and overall appropriateness of a fund for inclusion as an investment option within a selected qualified retirement plan.

FIGS. 4A-4K illustrate one embodiment of a reporting scheme provided to fiduciaries detailing results of investment option evaluation and analysis, which ties into monitoring requirements and guidelines set forth in an Investment Policy Statement.

FIGS. 5A and 5B depict a graphical user interface, in accordance with one embodiment of the present invention, providing an interactive reporting scheme of the retirement plan advisory system of FIG. 1.

FIGS. 6A-6E illustrate one embodiment of a provider/product evaluation report output generated for the fiduciaries.

FIGS. 7A-7C depict graphical user interfaces, in accordance with one embodiment of the present invention, providing an interactive Producer Services dialogue for selecting and evaluating funds for inclusion in a plan of the retirement plan advisory system of FIG. 1.

In these figures like structures are assigned like reference numerals, but may not be referenced in the description of all figures.

### DETAILED DESCRIPTION OF THE PREFERRED EMBODIMENTS

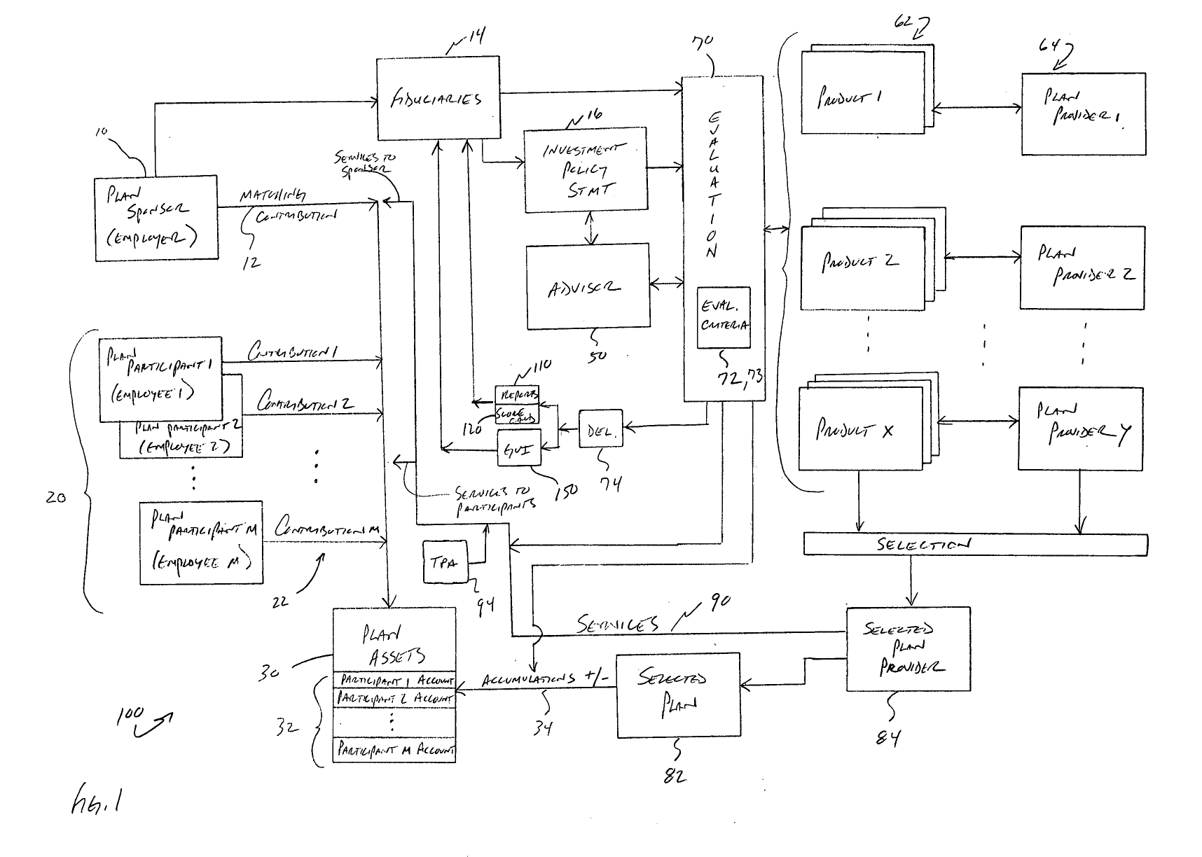

FIG. 1 shows a retirement plan advisory system 100, configured and operating in accordance with one embodiment of the present invention, for providing advice to fiduciaries of an employer that are evaluating and selecting a plan provider, its proposed product and corresponding investment options, such as, for example, plans complying with Internal Revenue Code, Sections 401(k), 403(b), and 457, to be offered to employees for retirement savings and like investments. As shown in FIG. 1, an employer or plan sponsor 10 wishes to provide a qualified retirement plan for the benefit of its employees or plan participants 1-M, shown generally at 20. Each of the plan participants 20, at their option and upon qualifying, may make contributions, shown generally at 22, to the plan for their retirement savings. In one embodiment, the plan sponsor 10 may also contribute to an individual plan participant's retirement savings by way of, for example, a matching contribution 12. While the retirement savings of each individual plan participant 20 are held for the benefit of that participant, e.g., in a participant's retirement account, shown generally at 32, the total contributions are collectively held as plan assets 30. It should be appreciated that the assets (e.g., dollar amounts) within the plan assets 30 do not sit idle awaiting retirement and eventual withdrawal by the plan participants 20, but rather are invested in accordance with a plan created by the plan sponsor 10 and offered to the plan participants 20. The investment is intended to accumulate additional assets (e.g., appreciate) over time such that the overall value of a plan participant's retirement savings account 32 increases in value. It should be appreciated that accumulations, shown generally at 34 in FIG. 1, may be positive or negative values depending on the relative success or failure of a particular investment.

An entire industry has formed to help plan sponsors 10 invest assets in qualified retirement plans. Given the diversity of entities and investment options available within the industry, plan sponsors 10 often select financial savvy corporate employees, officers and/or committees of the same (e.g., fiduciaries 14) to oversee the creation of appropriate plans and investment options therein. As noted above in the Background Section, complex rules, accounting procedures and reporting schemes are imposed by state and federal regulatory agencies such as, for example, the U.S. Department of Labor (DOL), U.S. Securities and Exchange Commission (SEC) and IRS, to oversee retirement plans. Typically, the fiduciaries 14 retain professional advisors (e.g., an advisor 50) to advise them in the setup, operation and monitoring of a retirement plan from the diverse entities and options available.

It is a goal of the fiduciaries 14 and advisor 50 to enhance investment opportunities for plan participants 20, while also minimizing, if not eliminating, exposure to liability (e.g., personal and corporate liability) for a failure to provide a compliant or successful retirement plan. Accordingly, the fiduciaries 14 and advisor 50 establish an Investment Policy Statement 16 outlining the process for selecting, monitoring and evaluating investment options within a desired plan. The Investment Policy Statement 16 assists the fiduciaries 14 by ensuring that they make investment-related decisions in a prudent manner. For example, the Investment Policy Statement 16 outlines underlying philosophies and processes for the selection, monitoring and evaluation of investment options utilized within the retirement plan by, for example: defining the plan's investment objectives; defining roles of those responsible for the plan's investments; describing criterion and procedures for selecting investment options; establishing investment procedures, measurement standards and monitoring procedures; and describing ways to address investment options and investment managers that fail to satisfy established objectives.

As can be appreciated, the selection of investment options offered under a plan is an important responsibility of the fiduciaries 14. The plan should provide an appropriate range of investment options that span the risk/return spectrum, while also allowing plan participants 20 to construct portfolios consistent with their unique individual circumstances, goals, time horizons and tolerance for risk. Generally speaking, most plans include investment options within a variety of asset classes such as, for example, conservative investments (e.g., including cash and liquid investments such as money market, stable value, and guaranteed interest accounts), income investments (e.g., including income oriented investments such as bond funds with low, medium, and high quality, and short, intermediate, and long term duration), equity investments (e.g., including funds that invest in equity securities, both domestic and foreign, including small, medium, and large market capitalization, value, blend, and growth investment objectives, sector, actively managed, and indexed), managed accounts (e.g., including accounts that invest in a combination of conservative, income, and equity investments) and other investments (e.g., real estate and real estate investment trusts, commingled real estate equity investments, self-directed brokerage accounts, bank certificates of deposit, insurance company separate accounts through a group annuity contract, and mutual funds).

The Investment Policy Statement 16 also provides for regular and disciplined monitoring and reporting of investment performance to fiduciaries 14. Regular monitoring confirms that the criteria originally satisfied remain so and that an investment option continues to be appropriate. Monitoring utilizes the same investment selection criteria of the original analysis. Unusual, notable, or extraordinary events are communicated by investment managers and/or vendors on a timely basis to the fiduciaries 14. Examples of such events include portfolio manager or team departure, violation of investment guidelines, material litigation against the firm, or material changes in firm ownership structure, or announcements thereof. As described in detail below, a “score card” for each investment manager (e.g., fund) is maintained and updated to substantiate acceptable levels of manager performance and appropriate style characteristics over a period of time. If a fund fails to meet the criteria standards, as determined by its score, it is placed on a “watch list.” In the event a fund receives a score which is below that of “watch list” status, or experiences extraordinary circumstances which may render it inappropriate to maintain, it may be considered for removal at the earliest feasible date. If a fund continues to remain on “watch list” for a predetermined evaluation period (e.g., a next three financial quarters), the fund is considered for possible elimination from the plan.

The Investment Policy Statement 16 also includes guidelines for providing investment and educational information, written disclosures (e.g., governmental disclosure requirements) and administrative reports to fiduciaries 14 and participants 20.

In accordance with the Investment Policy Statement 16, the fiduciaries 14 and advisor 50 evaluate retirement products and services, e.g., products 1-X shown generally at 62, offered by a number of plan providers or vendors, e.g., plan providers 1-Y shown generally at 64. As illustrated in FIG. 1, each of the plan providers 64 may offer one or more investment products 62. The evaluation, illustrated generally at 70, includes an analysis of the components and investment options of each of the products 62, for example, administration, record keeping, compliance to regulatory mandates, investment management, technology services, communication to plan participants, and total cost of the product(s) 62, e.g., investment fees paid by plan participants 20 to the investment managers and administrative fees paid by the plan sponsor 10 to the plan provider 64.

In accordance with one aspect of the present invention, the advisor 50 provides services including, for example, the following, to the fiduciaries 14 and, in effect, the plan sponsor 10:

| Services | How Provided |
|---|---|
| 1. Protect plan fiduciaries and executives | Performing U.S. Internal Revenue Code, |
| from financial loss due to DOL and IRS | Section 404(a) monitoring |
| imposed penalties, ERISA and plan participant | Providing an Investment Policy Statement |
| civil litigation, and legal fees associated with | template |
| these activities | Performing an investment due diligence |
| | process |
| | Providing Internal Revenue Code, Section |
| | 404(c) employer and employee policy |
| | templates |
| | Providing a 404(c) Guide Book^{SM} |
| 2. Minimize total plan costs and maximize | Performing plan provider contract review |
| the scope and quality of plan provider services | Performing plan provider pricing renegotiation |
| | Performing RFP provider analysis and |
| | benchmarking |
| 3. Maximize investment return potential, | Performing quantitative and qualitative |
| while minimizing risk/volatility | analysis |
| | Providing a Scorecard^{SM} fund ranking system |
| 4. Maximize plan efficiency and compliance | Providing a Fiduciary Plan Review^{SM} |
| | summary |
| | Providing plan design review and analysis |
| 5. Maximize benefits for plan participants | Conducting group and individual meetings |
| | Providing employee communication strategies |
| | Providing asset allocation and investment |
| | guidance/advice |
| | Providing individual financial advisory |
| | services (financial plans, Section 529 plans, |
| | and rollover and IRA solutions) |
| | Deferring compensation for services |

In one embodiment, a 404(c) Guide Book^{SM} (GUIDE BOOK is a service mark of 401(k) Advisors, Aliso Viejo, Calif. USA) provides fiduciaries with information and strategies for becoming and staying 404(c) compliant, while a Fiduciary Plan Review^{SM} (FIDUCIARY PLAN REVIEW is also a service mark of 401(k) Advisors) advises fiduciaries of their duties and responsibilities under applicable law, and to provide guidance in formulated compliant plans.

In summary, the advisor 50 assists the fiduciaries 14 in identifying a plan provider 64 that delivers the highest quality products and services at the most competitive total plan cost, e.g., identifying and selecting a preferred product or products within the available products 62 to be included in the qualified retirement plan offered to plan participants 20. As can be appreciated, it is desirable to provide a mechanism for evaluating each product in a standardized way.

As noted above, each retirement plan includes components 62A that collectively define the plan services. Plan components 62A include, for example, the following:

| Plan Component | Description |
|---|---|
| 1. Record Keeping | Participant-level record keeping/accounting |
| | Employee and employer reports |
| | Tracking investment allocations/changes and |
| | contribution changes |
| 2. Technology Services | Services that enhance plan efficiency, |
| | productivity, understanding and value |
| | State-of-the-art technology |
| | Web-based participant investment tools |
| | Web-based employer tools |
| 3. Employee | Materials describing plan design and investing |
| Communication | Enrollment kits |
| | Payroll stuffers, posters and memos |
| | Newsletters |
| 4. Compliance | Plan documents |
| | Summary plan description |
| | Annual 5500 and pertinent schedules |
| | ERISA plan audit (if applicable) |
| | Discrimination testing |
| 5. Investment | All available investment offerings including |
| Management | cash, income, hybrid and equity investments |
| | Proprietary, sub-advised, retail, and index |
| | investments |
| 6. Cost | Hard dollar fees that are a specific amount - |
| | paid by the employer, including participant |
| | record keeping, compliance, loan |
| | administration, hardship and distribution |
| | fees |
| | Soft dollar fees that are specific percentage - |
| | generally paid by employees for investment |
| | management expenses and to subsidize |
| | some or all of the administrative fees |

The inventors have realized that any analysis of retirement plans should focus on each of the aforementioned components 62A. Accordingly, the advisor 50 and the fiduciaries 14 analyze the components 62A in a number of products 62 to benchmark plan providers 64 for comparison. In one aspect of the present invention, the analysis applies, for example, the following evaluation criterion 72 per plan component 62A, of which the percentage weightings to each may change based on underlying factors. It should be appreciated that weight percentages may be adjusted (e.g., increased or decreased) to provide greater or lesser focus to one or more areas within the evaluation criterion 72.
1. Investment Management, approximately 25% of evaluation criteria
Criteria: Asset charge proprietary/non-proprietary funds
   Miscellaneous add-on fund expenses
   Guaranteed and stable value account styles
   Proprietary investment management expense
   Sub-advised investment management expense
   Breadth of index funds and investment management expenses
   Retail fund investment management expense
   Investment return (proprietary, sub-advised, non-proprietary, asset allocation funds)
   Asset class and investment style coverage
   Access to open architecture investment choices
   Ease of understanding (share v. unit accounting)
   Ability to add, delete and freeze funds
   Internal qualitative investment due diligence process
   Investment selection flexibility
   Managed portfolio options
   Life Time (automatically rebalanced)
   Manager of manager sub-advised risk-adjusted funds
   Custom asset allocation accounts
   Scorecard^{SM} rankings
2. Record Keeping, approximately 25% of evaluation criteria
Criteria: Experience/expertise
   Record keeping system origin (e.g., leased or proprietary)
   Percentage of budget allocated to record keeping system maintenance
   Reporting timeliness and reliability
   Reporting accuracy
   Quality assurance standards
   Termination and distribution processing
   Loan processing
   Other distributions (hardship, 59½, disability)
   Payroll and census transmittal system
   Plan deposit submission
   Employee report content and layout
   Conversion process
   Conversion management team
   Administrator to client ratio
   Administrator qualifications
   Client service tracking
   Tracking beneficiary designations
   Participant address changes
3. Total Plan Costs, approximately 15% of evaluation criteria
Criteria: Conversion fees
   Base administration fees
   Per participant fees
   Per eligible fees
   Investment management fees
   Asset charges
   Testing (compliance) fees
   Trustee fees
   Plan document fees
   Plan amendment fees
   Transaction fees
   Miscellaneous fees (loans, hardships, distributions, QDROs, etc.)
   Pricing guarantees
   Contract termination fees
   Market Value Adjustments
   Investment expenses
   Enrollment/Ongoing Education meetings
   Enrollment/Education materials (printing and postage)
   Fund change (addition/deletion fees)
4. Compliance Services, approximately 10% of evaluation criteria
Criteria: Compliance assistance and expertise
   Plan documentation
   Plan amendments
   SPD drafting and distribution
   1099 filing
   Minimum distributions
   5500 completion
   Standard discrimination testing
   Special discrimination testing (for non safe harbor pay definitions, multiple matching formulas, etc.)
   Coverage testing
   Late deposit monitoring
5. Technology and Participant Account Access, approximately 10% of evaluation criteria
Criteria: Automated Voice Response System
   Opt out of Automated Voice Response System to speak with live representative
   Toll-free customer service assistance
   Call Center (live customer service representatives) availability
   Plan sponsor website
   On-line plan management reports
   Participant website
   Web navigation ease
   Internet-based investment allocation tools and materials
   Individual investment advice
6. Employee Communication, approximately 10% of evaluation criteria
Criteria: Enrollment kits and other communication materials
   Enrollment process
   Enrollment meetings
   Local enrollers
   National enrollers
   Written investment allocation communication materials
   On-site meetings
   On-going assistance
   Web conferencing
   Print campaigns/materials
   Custom materials
7. Miscellaneous, approximately 5% of evaluation criteria
Criteria: Customer loyalty
   Target market match
   Vender name recognition
   Sales and service support/commitment
   Foreign language services
   IRA rollover services
   Vendor revenue sharing disclosure; redemption fees
   Third party validation (industry surveys, rankings, reports)
   Number of plans by number of employees
   Years offering Defined Contribution services
   Client retention (persistency)

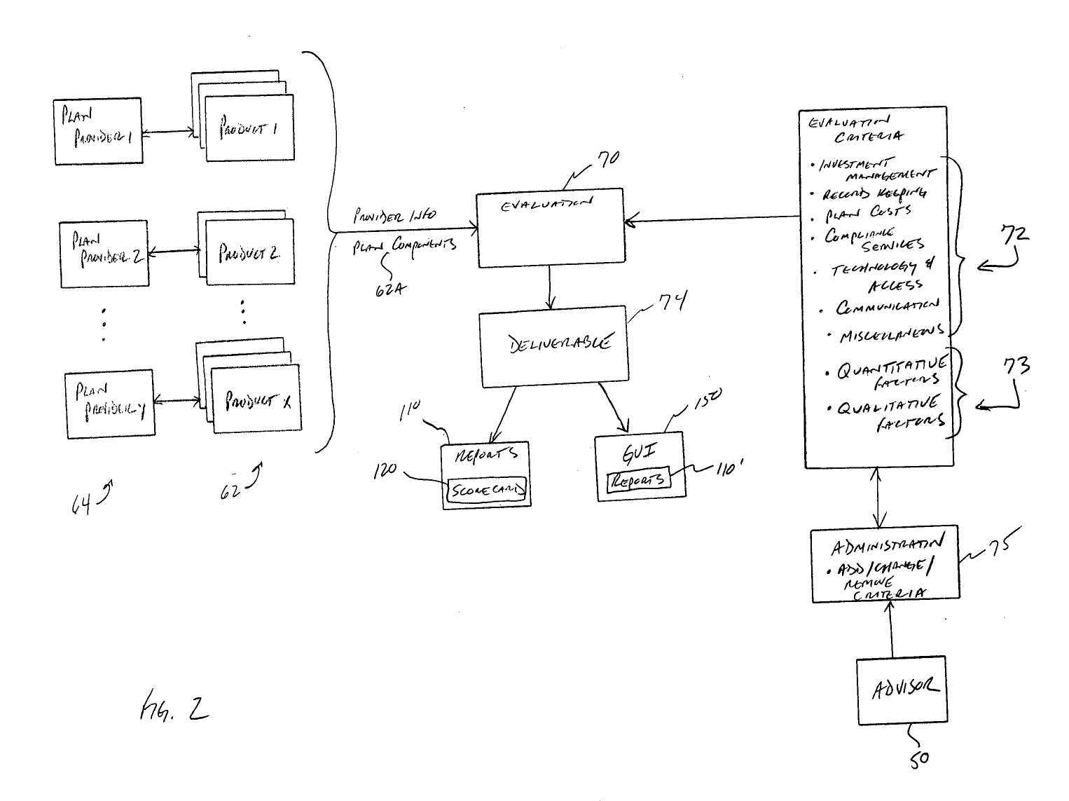

FIG. 2 illustrates one embodiment of the evaluation process 70 in greater detail. As shown, information regarding plan providers 64 and plan components 62A of the products 62 offered by the plan providers 64 are provided to the evaluation process 70 by the plan providers 64 or by the advisor 50. Additionally, the aforementioned evaluation criteria 72 is also provided to the evaluation process 70.

In accordance with one aspect of the present invention, the advisor 50 provides the fiduciaries 14 with a deliverable 74 of the evaluation process 70 including results of a plan provider/product analysis. The deliverable 74 includes a summary of the evaluation in which the advisor 50 calculates a variety of attributes corresponding to the components 62A and how they match up to the evaluation criteria 72. In one embodiment, the deliverable 74 and the attributes included therein are presented, for example, by means of a number of reports 110 on the qualified plan providers 64. In another embodiment, the deliverable 74 is presented by means of a graphical user interface (GUI) 150.

One of the reports 110 is a Scorecard^{SM} report 120 (SCORECARD is a service mark of 401(k) Advisors, Aliso Viejo, Calif. USA). The Scorecard^{SM} report 120 provides a numeric value, based on objective criteria derived from the Modern Portfolio Theory concepts, for evaluating manager performance, style characteristics and investment strategies. In one embodiment, the Scorecard^{SM} report 120 scoring is built around a “pass/fail” criteria on a numeric scale ranging from zero to ten (0-10), with ten (10) being a “best” score. Within the Scorecard^{SM} report 120, rankings equate such that nine to ten (9-10) points is “good”, seven to eight (7-8) points is “acceptable”, five to six (5-6) points implies that a fund should be “watched”, and zero to four (0-4) points is “below acceptable”. The Investment Policy Statement 16 serves as the “roadmap” for fiduciaries 14 in determining whether to “watch-list”, add, or delete a fund, based on the numeric value (e.g., score) of the fund presented in the Scorecard^{SM} report 120.

The Scorecard^{SM} methodology incorporates quantitative and qualitative factors 73 as additional evaluation criteria 72 within the evaluation process 70. Eighty percent (80%) of a fund's score is quantitative incorporating eight factors described below. In one embodiment, the fund is awarded one (1) point if the fund passes and zero (0) points if the fund fails the quantitative criteria. The funds within a product 62 are evaluated over a five-year period, unless a fund in a particular asset class has less than five years performance. Funds with less than five but at least a three-year performance measure may be included. However, a fund with less than the three-year performance is eliminated from the evaluation. The remaining twenty percent (20%) of the fund's score is qualitative. In one embodiment, the fund may be awarded zero (0), one (1) or two (2) points based in the qualitative part of the analysis, which are generally described below.

Quantitative Factors include, for example:
1. Style Analysis: Returns-based analysis to determine the style characteristics of a fund over a period of time. A fund passes if it reflects the appropriate style characteristics.
2. Rolling Style Analysis: Returns-based analysis to determine the behavior of the fund/manager over multiple (rolling) time periods. A fund passes if the fund exhibits a consistent style pattern.
3. Risk/Return: A fund passes if its risk is less that the benchmark or its return is greater than the benchmark.
4. R-Squared: Measures the percentage of a fund's returns that are explained by the benchmark. A fund passes if it has an R²>80%.
5. Up/Down Capture Analysis: Measures the behavior of a fund in up and down markets. A fund passes with an up capture greater than its down capture.
6. Information Ratio: Measures a fund's relative risk and return. A fund passes is the information ratio is greater than zero.
7. Returns Peer Group Ranking: A fund passes if its median rank is above the 50^{th} percentile.
8. Information Ratio Peer Group Ranking: A fund passes if its median rank is above the 50^{th} percentile.

Qualitative Factors include, for example:
1. Manager tenure.
2. Fund expenses.
3. Strength/significance of statistics
4. Quality of firm, resources and reputation.
5. Pending litigation, legal and/or governance issues.
6. Other factors which may impact the fund's management.

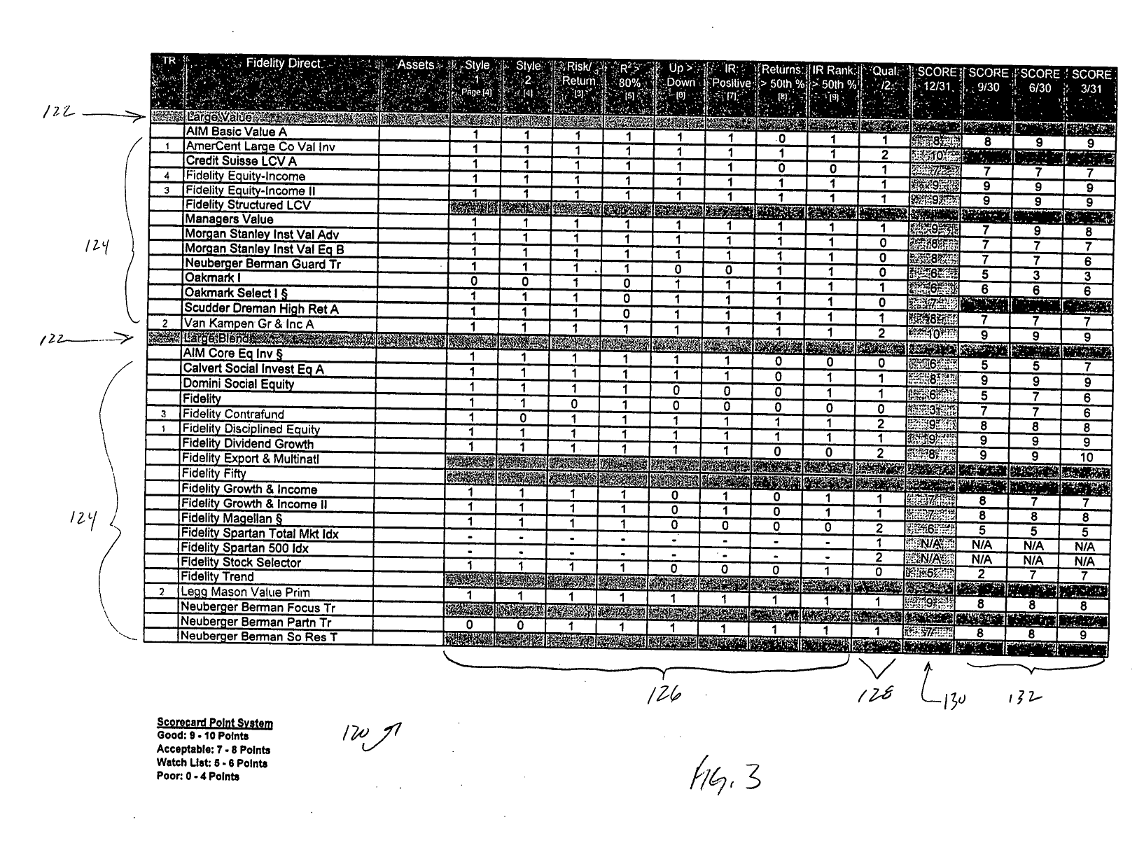

The inventors have determined that the combined quantitative and qualitative factors 73 provide a measure of the relative performance, characteristics, behavior and overall appropriateness of a fund for inclusion into the selected qualified retirement plan as an investment option. One embodiment of an exemplary Scorecard^{SM} report 120 is illustrated in FIG. 3. As shown in FIG. 3, an analysis of funds 124 within a plurality of asset classes 122 (e.g., large cap, mid cap, small cap, value and growth classes, etc.) is presented in a tabular fashion where “scores” of the aforementioned quantitative factors, shown generally at 126, and qualitative factors 128 are provided. The inventors have also realized that effective plan provider/product selection is a multiple step process that includes a plan provider analysis (e.g., ensure financial strength and future market commitment) and an evaluation of product and services capabilities (e.g., gage an ability to deliver excellence with all plan components), delivery system compatibility (e.g., evaluate the delivery of provider services to ensure they fit plan sponsor and plan participant needs), and demographical compatibility (e.g., ensure a plan provider is committed to plans like those needed by the plan sponsor).

It should be appreciated that an investment due diligence approach, as provided herein, is unique in how information is assembled within the Scorecard^{SM} report 120. The Scorecard^{SM} report 120 encompasses primary factors (e.g., the quantitative factors 126 and qualitative factors 128) fiduciaries 14 must consider when making investment decisions, and provides a process to help identify the best investment managers available to the plan sponsor 10. A total score 130 is provided based upon an accumulation of the quantitative factors 126 and qualitative factors 128 for a given fund. In one embodiment, total scores of previous analysis 132 (e.g., recent, past financial quarters) is also provided so that trends in performance can also be shown.

It should also be appreciated that the evaluation process 70 (wherein plan provider/product analysis is performed) is unique in that it utilizes a balanced approach of incorporating both investment opportunity and total cost, a balanced analysis that is not used or applied in today's marketplace. The analysis balances the need for skillful investment managers with a competitively priced product. All other factors equal, the plan sponsor 10 and plan participants 20 are best served by a product with skillful investment managers available to the plan sponsor 10 and plan participants 20 at the lowest cost available. In this respect, investment due diligence does not only occur at the plan level, but, in fact, at the plan provider/product level part of the analysis and evaluation.

In one embodiment, the evaluation process 70 includes an administrative option 75. With the administrative option 75 the advisor 50 may update the information for each provider/product and/or update (e.g., increase or decrease) weights applied to one or more of the evaluation criteria 72 per plan component 62A (FIG. 2).

Once the components 62A of subject products 62 are evaluated, the evaluation 70 continues by focusing upon how the components of the products 62 are “delivered” to the plan sponsor 10 and plan participants 20. FIG. 1 illustrates delivery of the components, generally at 90, from a selected product 82 and, more appropriately, a selected plan provider 84. Generally speaking, there are two primary delivery systems for qualified retirement plans, bundled and unbundled. Bundled plan providers deliver all essential plan components 62A under one integrated approach. With an unbundled system, two or more organizations deliver plan services. For example, a third party administrator (TPA) 94 may be responsible for providing compliance services and limited book keeping (e.g., for plan participant loans and/or financial hardship withdrawals). As can be appreciated, there may be many hybrid combinations of unbundled delivery systems including, for example, multiple providers who deliver employee communications, record keeping, and technology services to the plan sponsor 10. The inventors have realized that both bundled and unbundled delivery systems work effectively under appropriate circumstances, demographics and conditions. Accordingly, it is important to measure the systems of subject plan to determine a “best fit” for the plan sponsor 10 and plan participants 20 on a case-by-case basis.

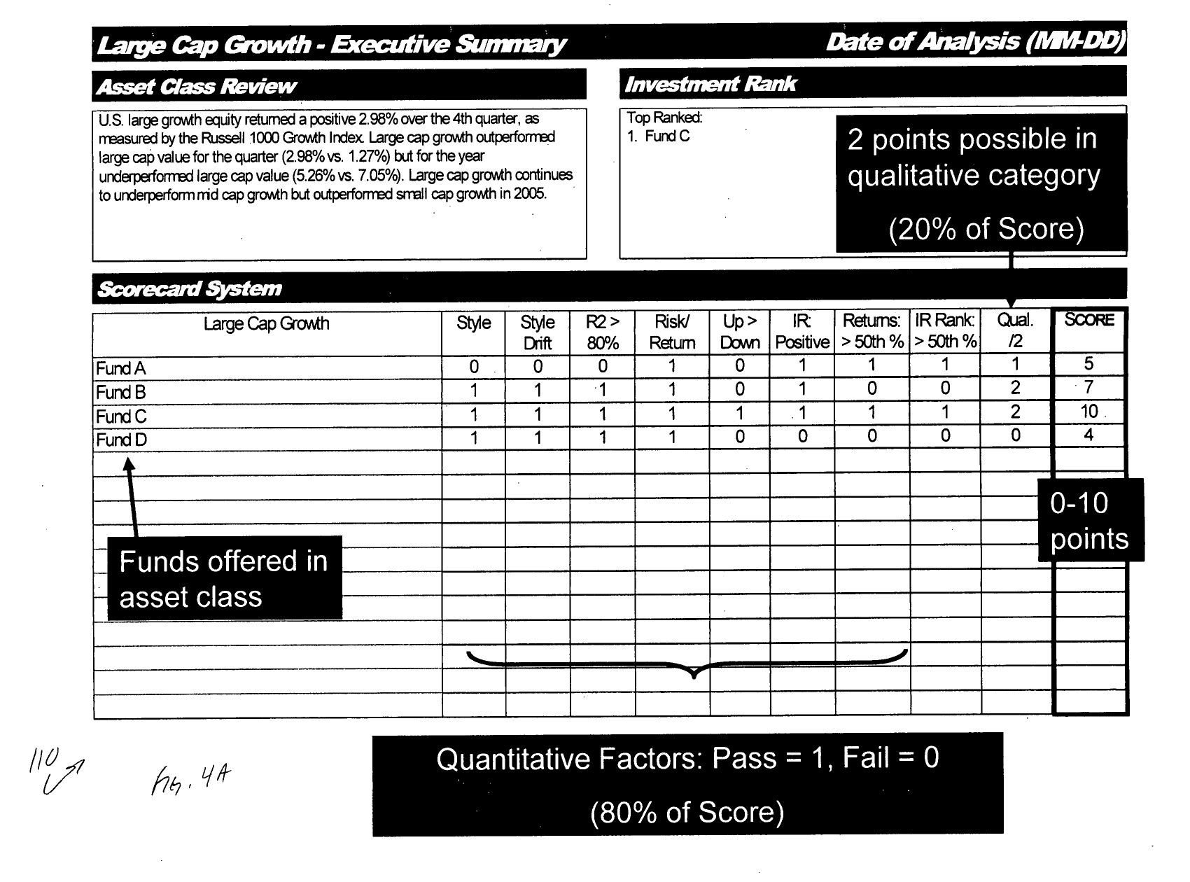

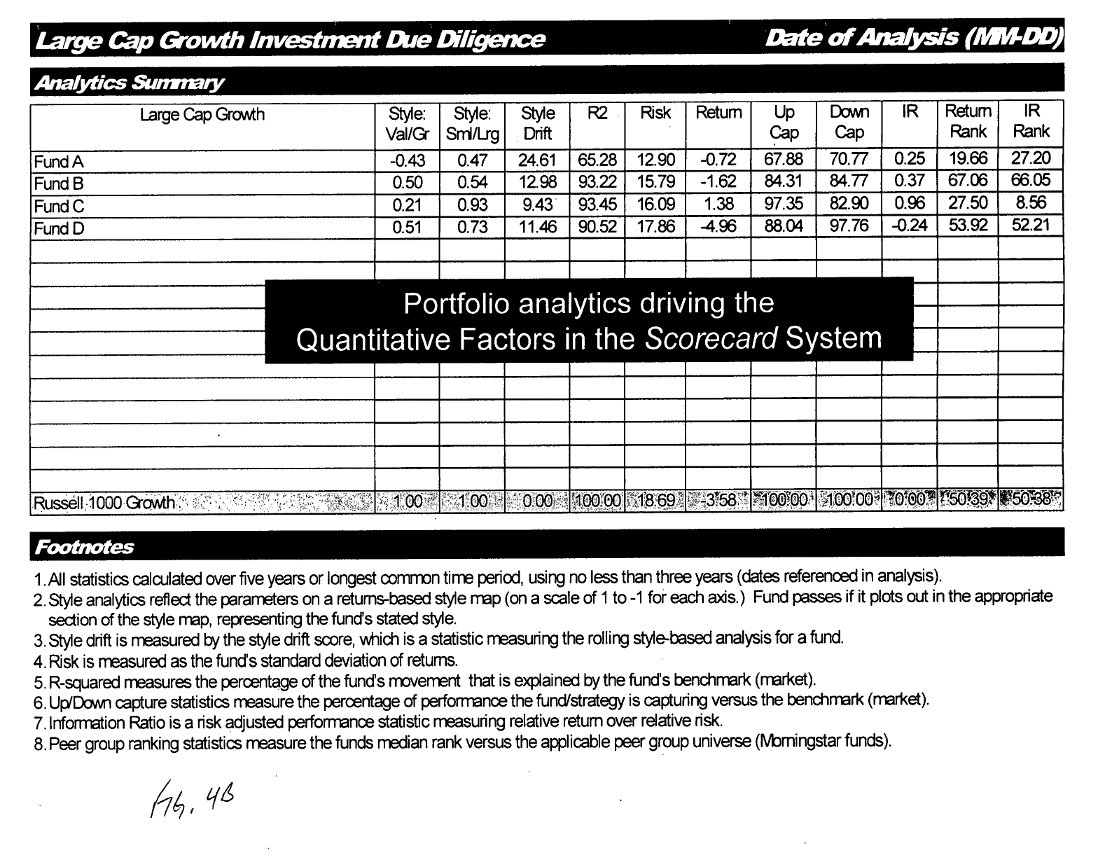

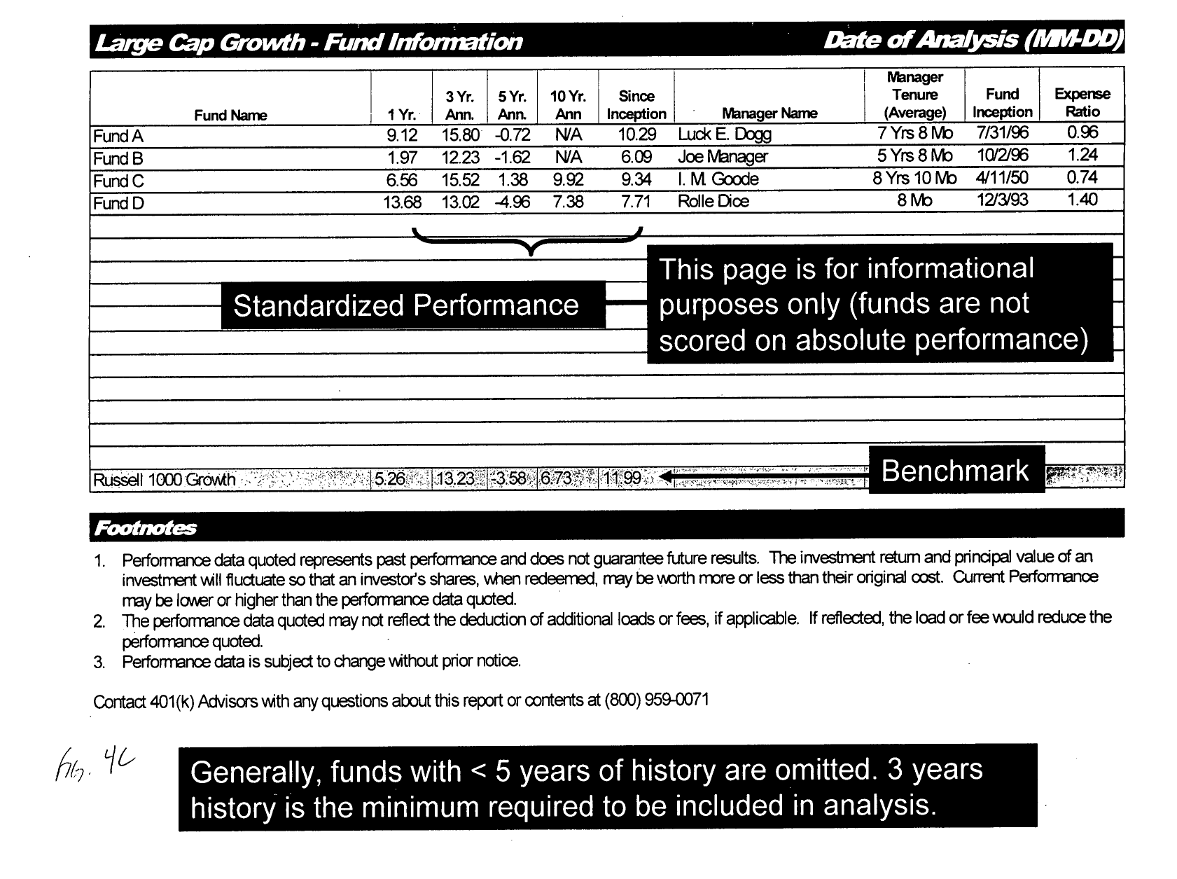

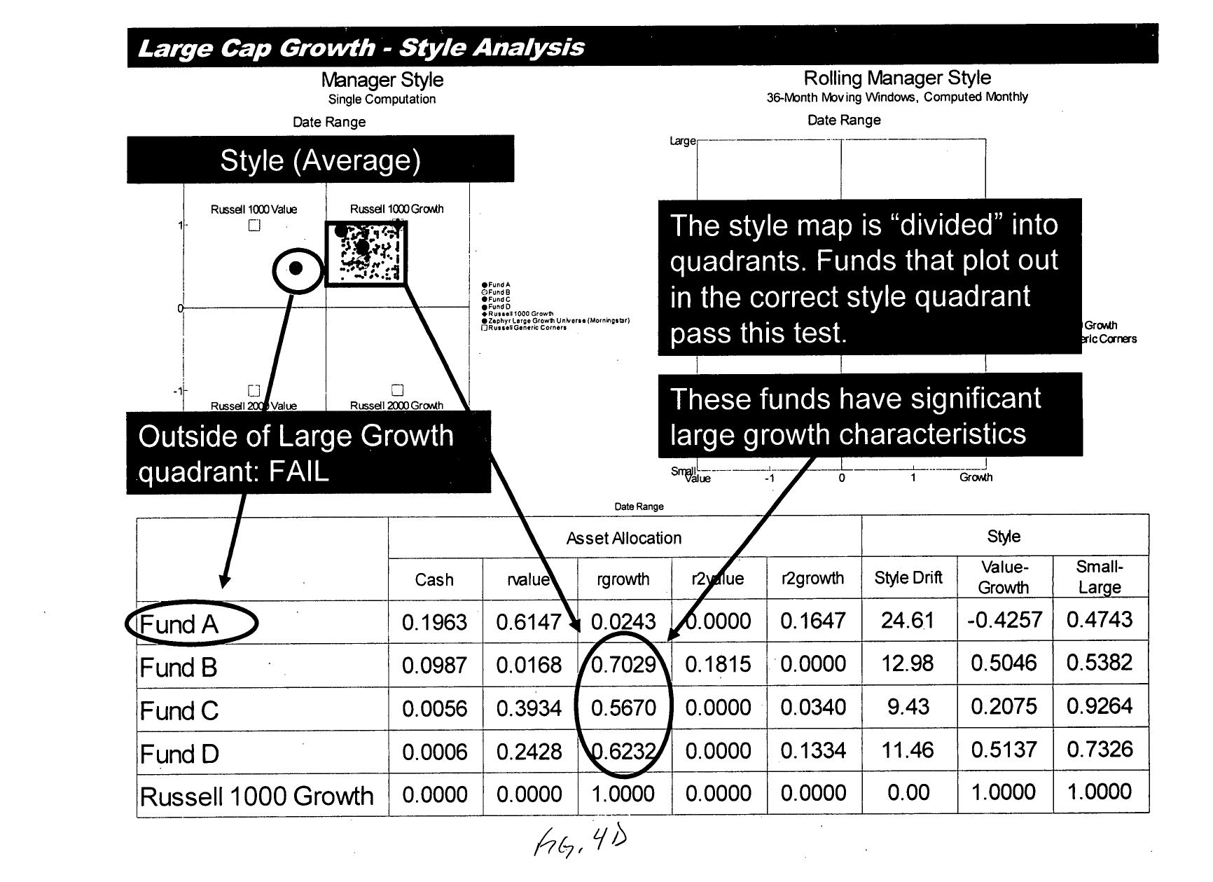

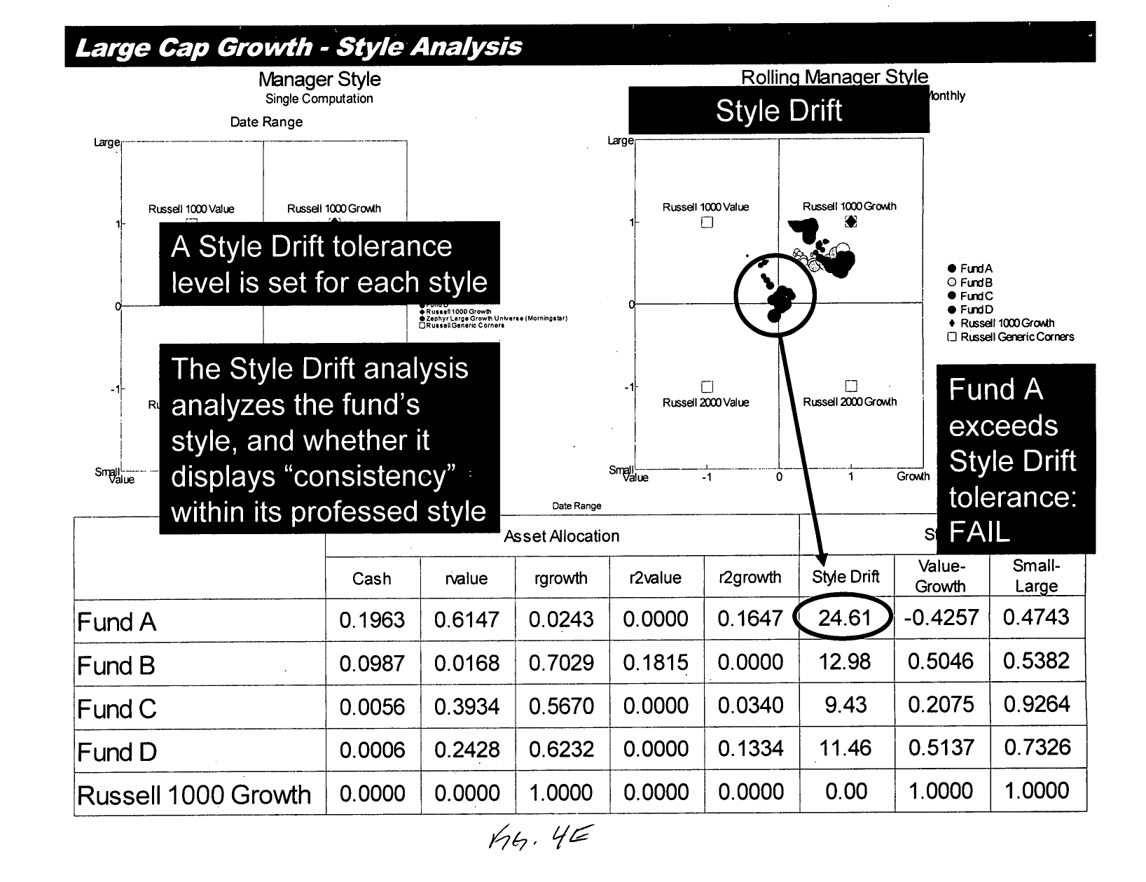

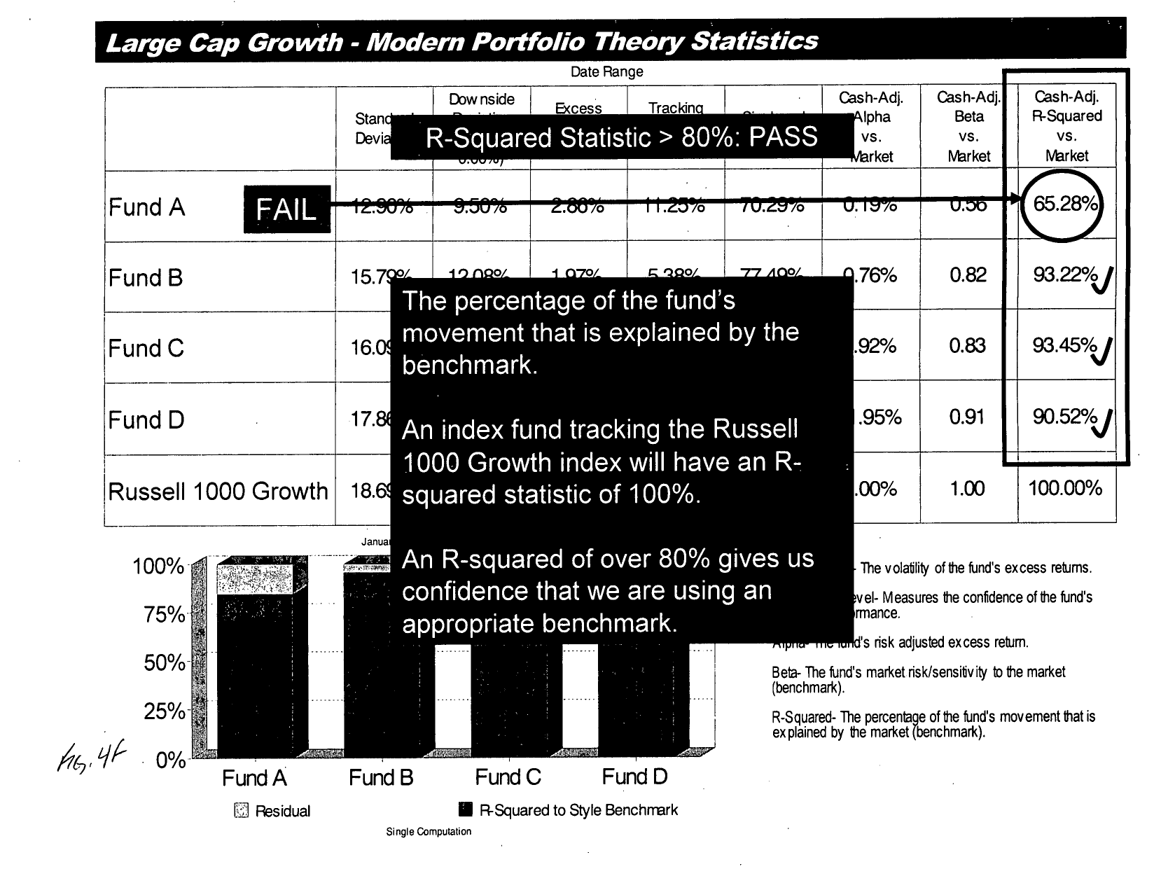

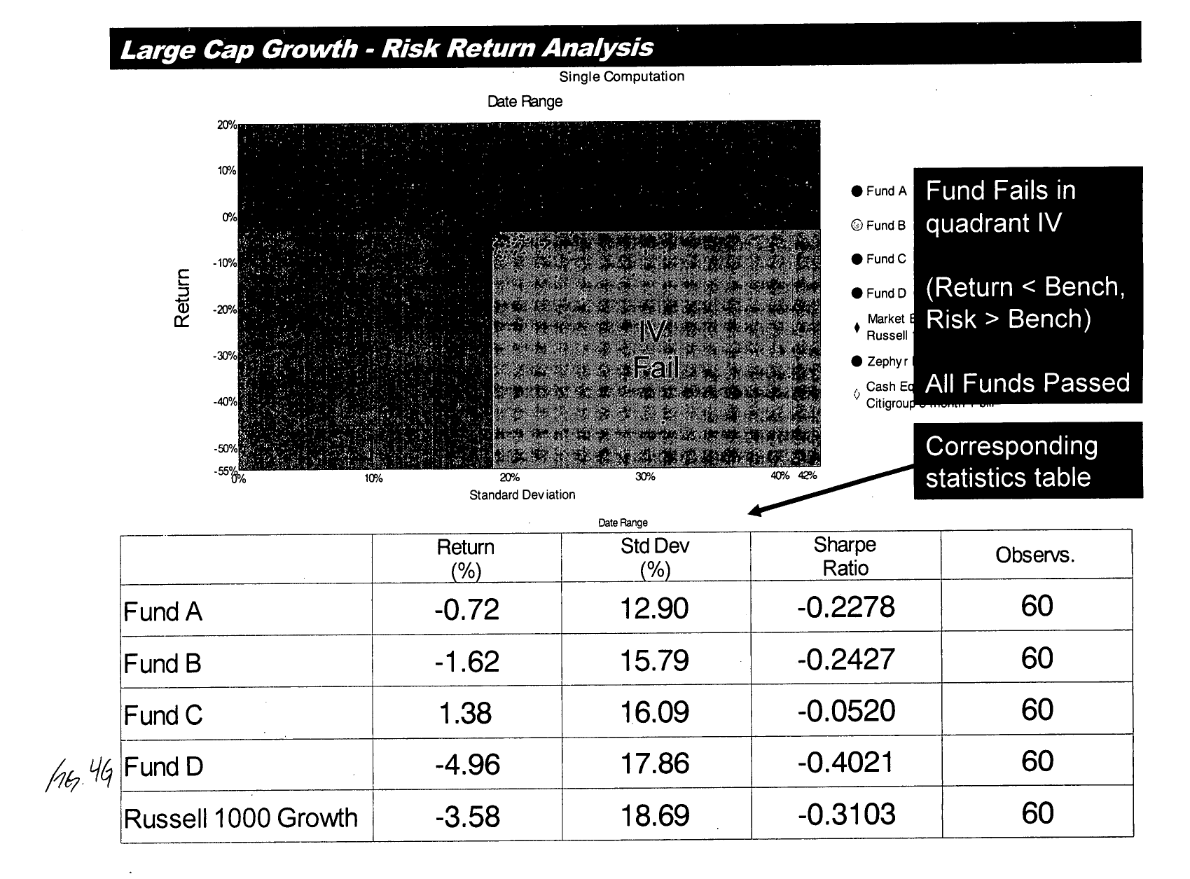

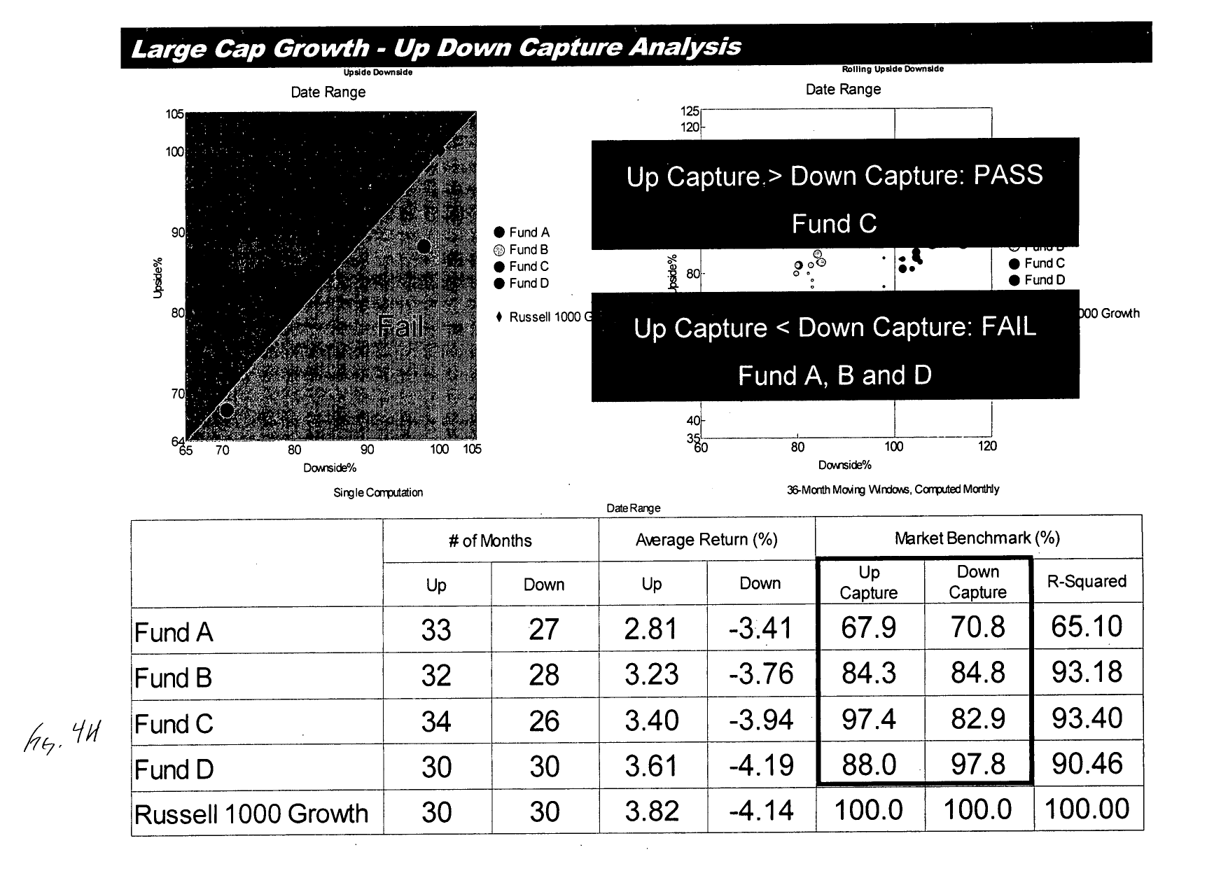

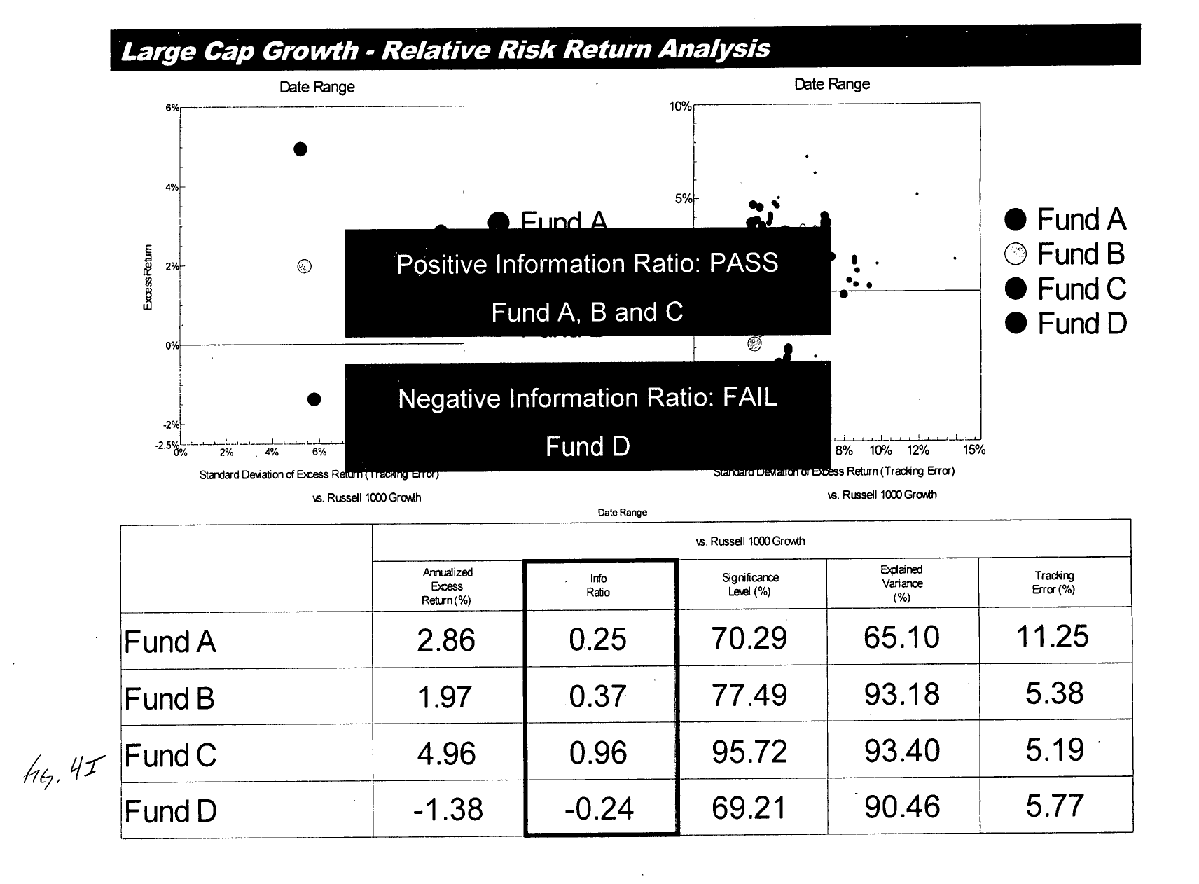

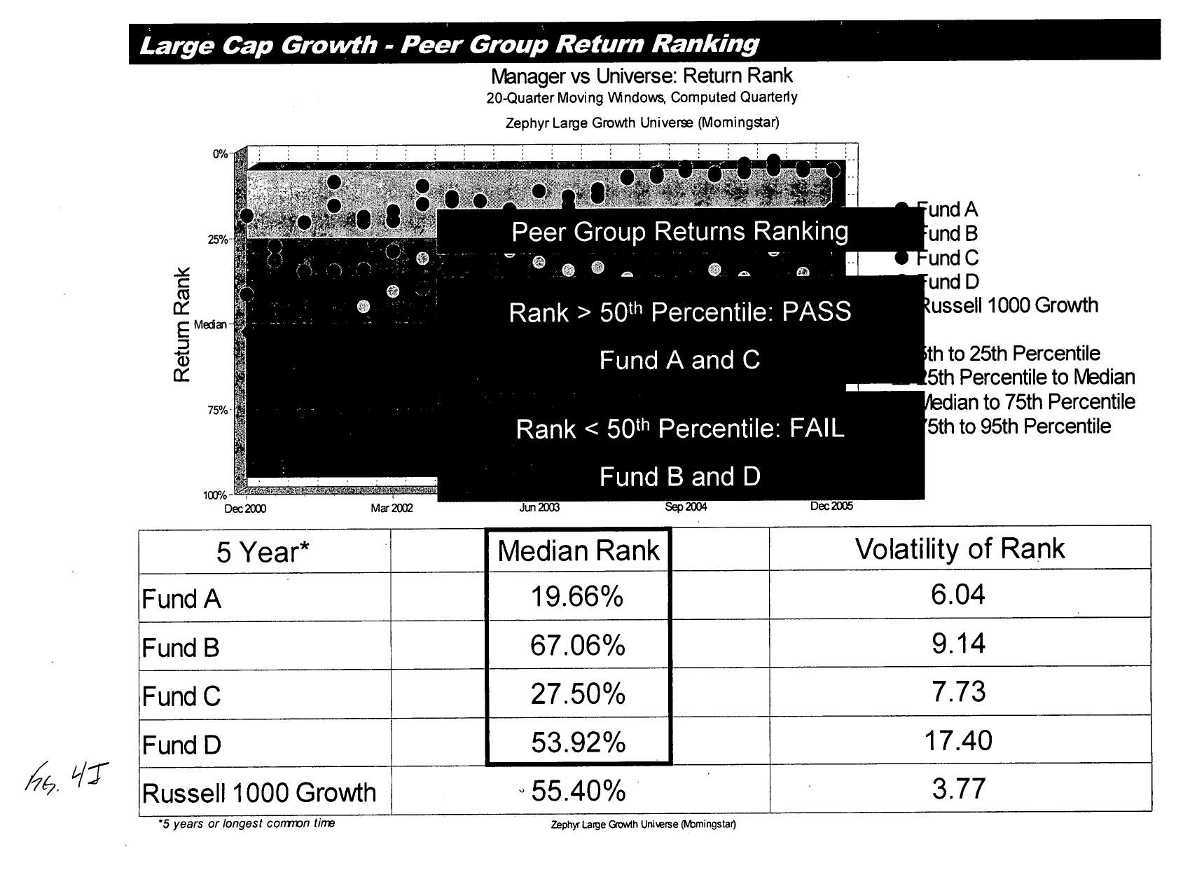

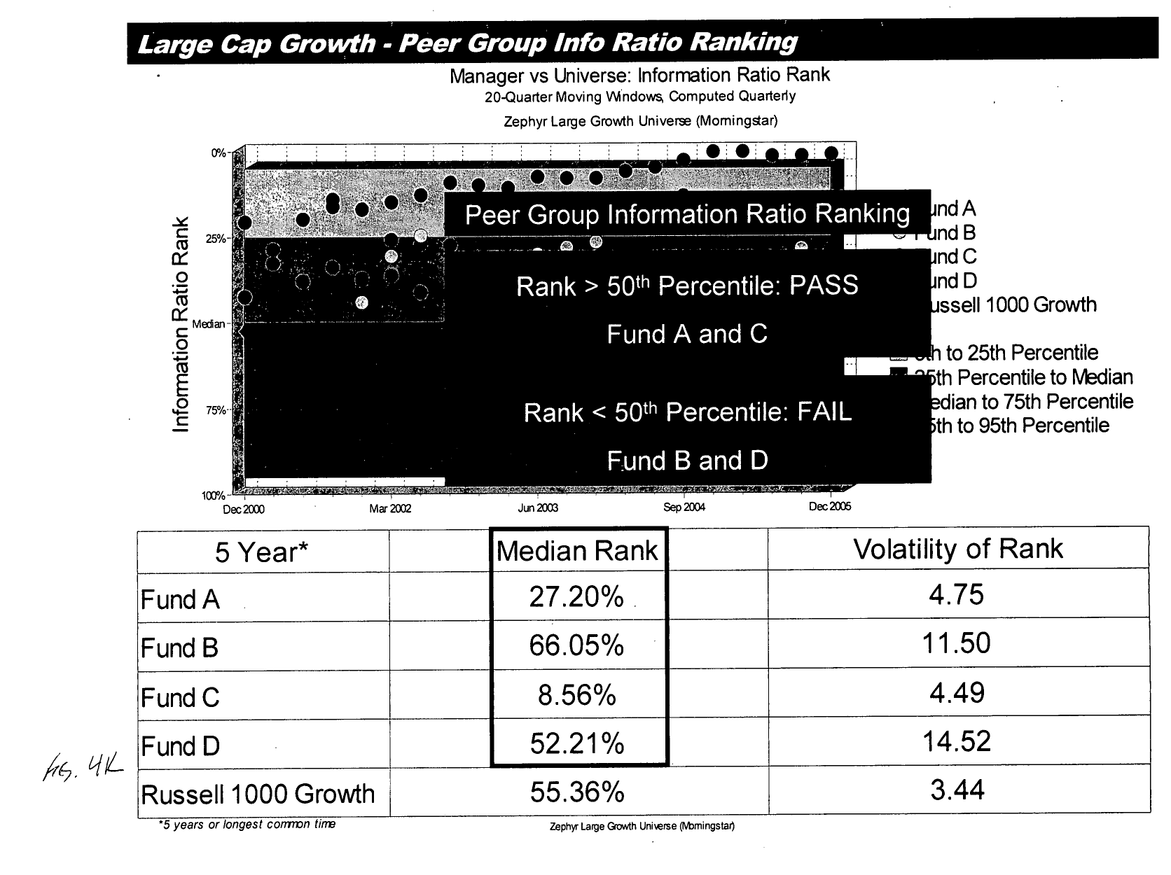

As noted above, the advisor 50 provides the fiduciaries 14 with the deliverable 74 including the reports 110 detailing the results of its evaluation of the various plan providers 64, plans 62 and their components. In one embodiment of the present invention the reports 110, including the aforementioned Scorecard^{SM} report 120, for funds within subject products 62 as well as plan provider 64/product 62 (e.g., vendor) score, is provided in documentary form. In one embodiment of the present invention, the plan provider/ product score is an average score that measures the plan provider's style box coverage and their best fund offering across, for example, twelve major style box categories. FIGS. 4A-4K illustrate one embodiment of a reporting scheme (e.g., the reports 110) distributed to the fiduciaries 14. As shown in FIGS. 4A-4K, the reports 110 include an executive review of the asset class and funds included in the class (FIG. 4A), the Scorecard^{SM} investment (e.g., fund) due diligence (FIG. 4B), fund performance information (FIG. 4C), style analysis showing average growth and drift (FIGS. 4D and 4E), the Modem Portfolio Theory statistics (FIG. 4F), risk/return analysis (FIG. 4G), up/down capture analysis (FIG. 4H), relative risk/return analysis (FIG. 4I) and peer group return and info ratio rankings (FIGS. 4J and 4K).

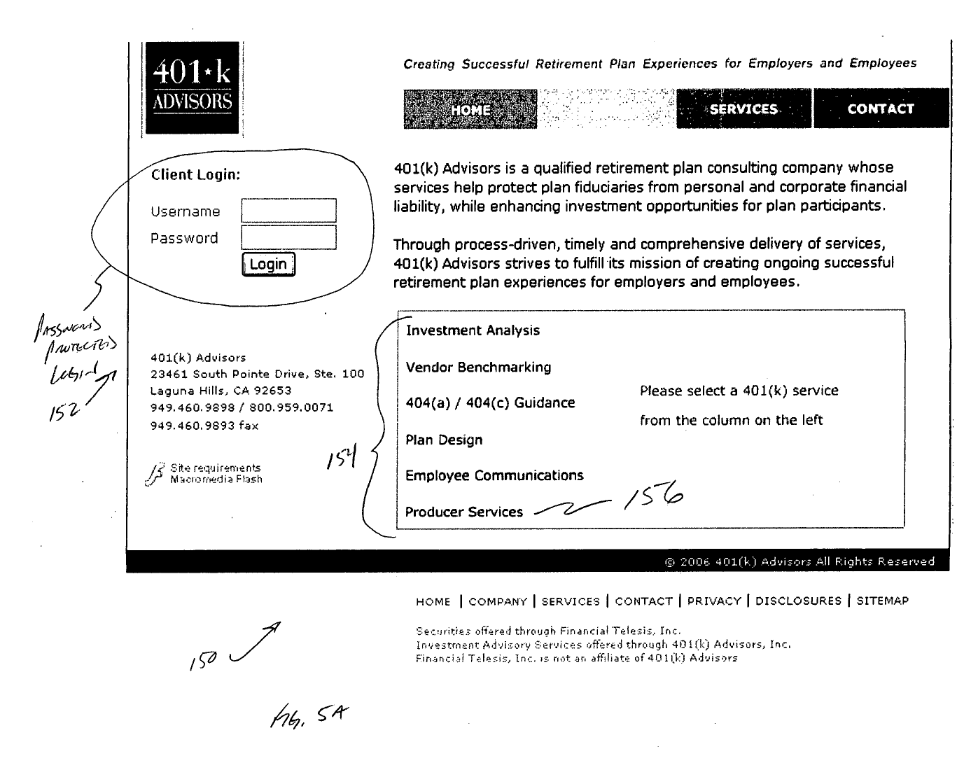

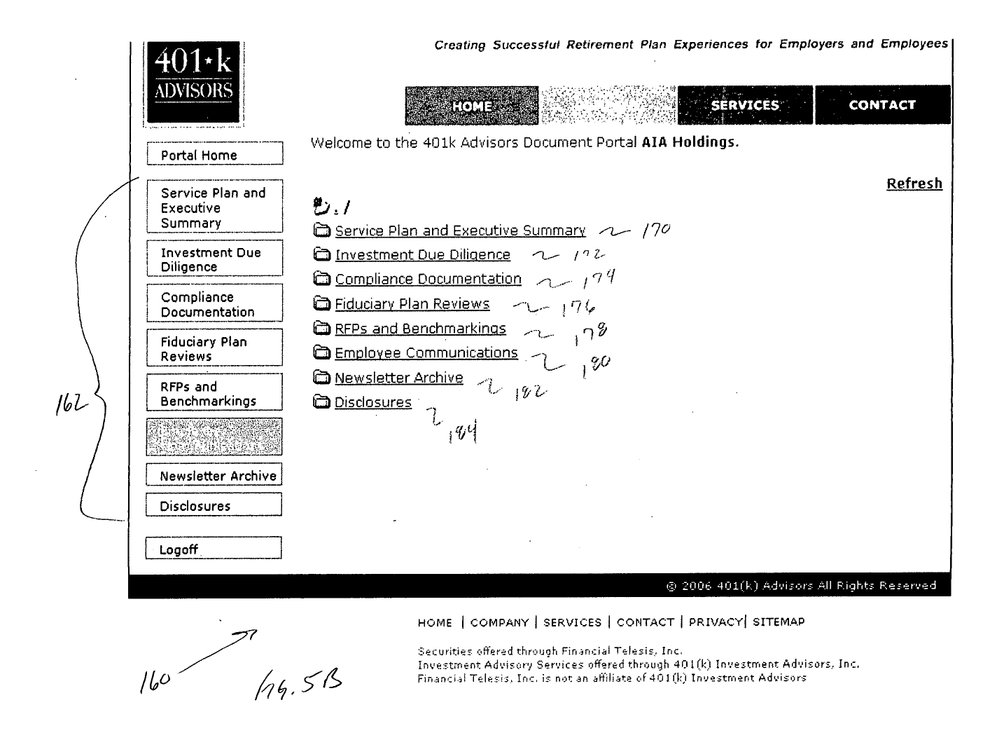

As noted above, in another embodiment, the deliverable 74 is provided to the fiduciaries 14, upon request, via an interactive graphical user interface (GUI) 150 (FIGS. 5A and 5B). As is generally known to those skilled in the art, the GUI 150 may be implemented on a server computer (not shown) accessed by the fiduciaries 14 by a computing device (not shown) such as a personal computer, hand held computer, personal digital assistant and like device for displaying content provided over a wired or wireless communications network such as the Internet, intranet or an extranet.

As shown in FIG. 5A, the fiduciaries 14 access the server by entering a user name and password, shown generally at 152, on the GUI 150. The GUI 150 provides a menu 154 displaying choices for invoking various services provided by the advisor 50. Once “logged on”, the GUI 150 provides a Portal home page 160 (FIG. 5B) including a sub-menu 162 of services offered by the advisor 50 such as, for example, Service Plan and Executive Summary 170, Investment Due Diligence 172, Compliance Documentation 174, Fiduciary Plan Reviews 176, RFP and Benchmarking 178, Employee Communication 180, Newsletter Archive 182 and Disclosures 184. In one embodiment, selecting Service Plan and Executive Summary 170 takes the user to an archived current and historical service plans and retirement plan meeting executive summaries conducted with the plan fiduciaries 14. Selecting Investment Due Diligence 172 takes the user to archived investment due diligence reports and scorecard analyses of the investments in their plan. Selecting Compliance Documentation 174 takes the user to reports needed to maintain a complaint retirement plan (e.g., reports meeting rules and regulations promulgated by governmental agencies). Selecting Fiduciary Plan Reviews 176 takes the user to archived Fiduciary Plan Reviews. Selecting RFP and Benchmarking 178 takes the user to archived RFP and benchmarking reports conducted for the plan fiduciaries 14. Selecting Employee Communications 180 takes the user to a broad array of communication materials devoted to educating employees (e.g., the plan participants 20). Selecting Newsletter Archive 182 takes the user to past newsletters created by the advisor 50 and selecting Disclosures 184 takes the user to any disclosures, including compensation disclosures, providing the fiduciaries 14 all information from which to make informed decisions.

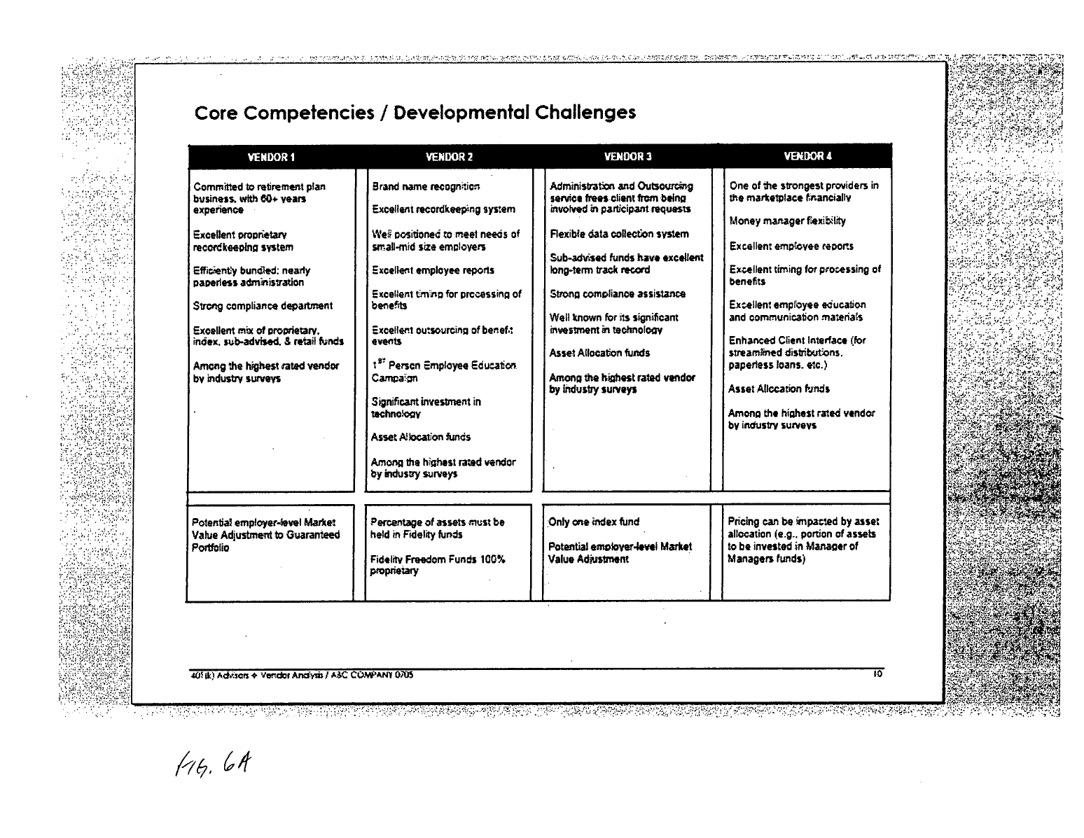

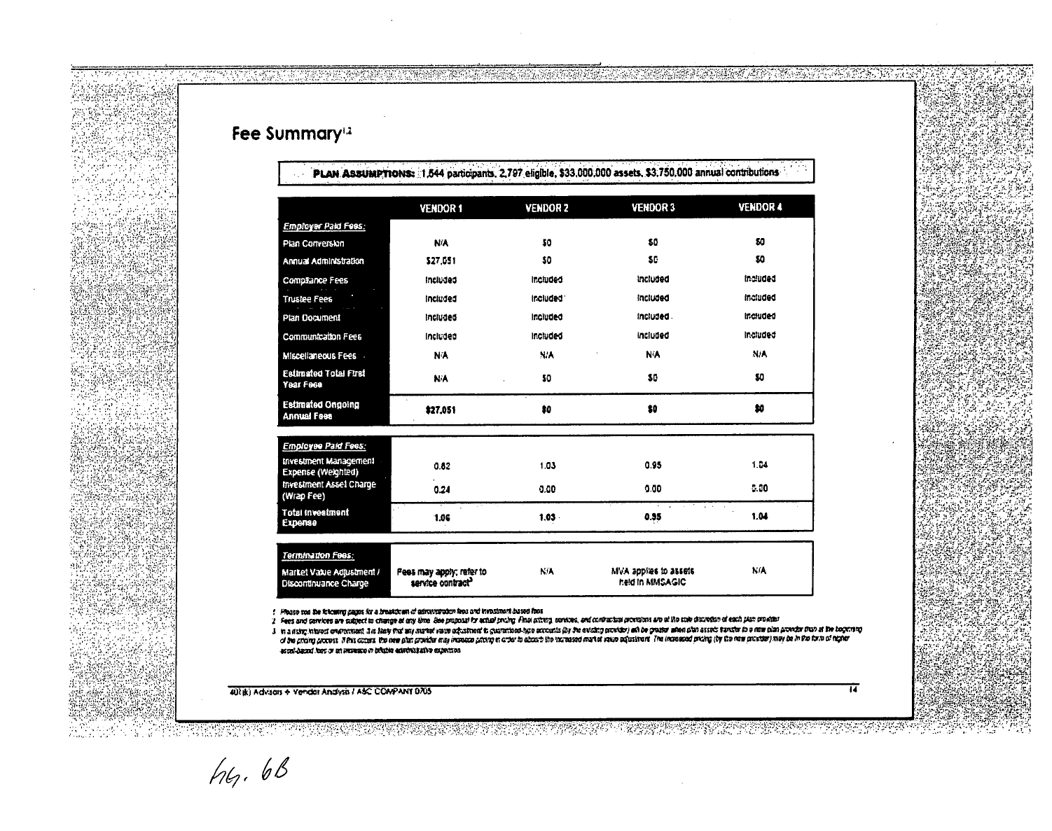

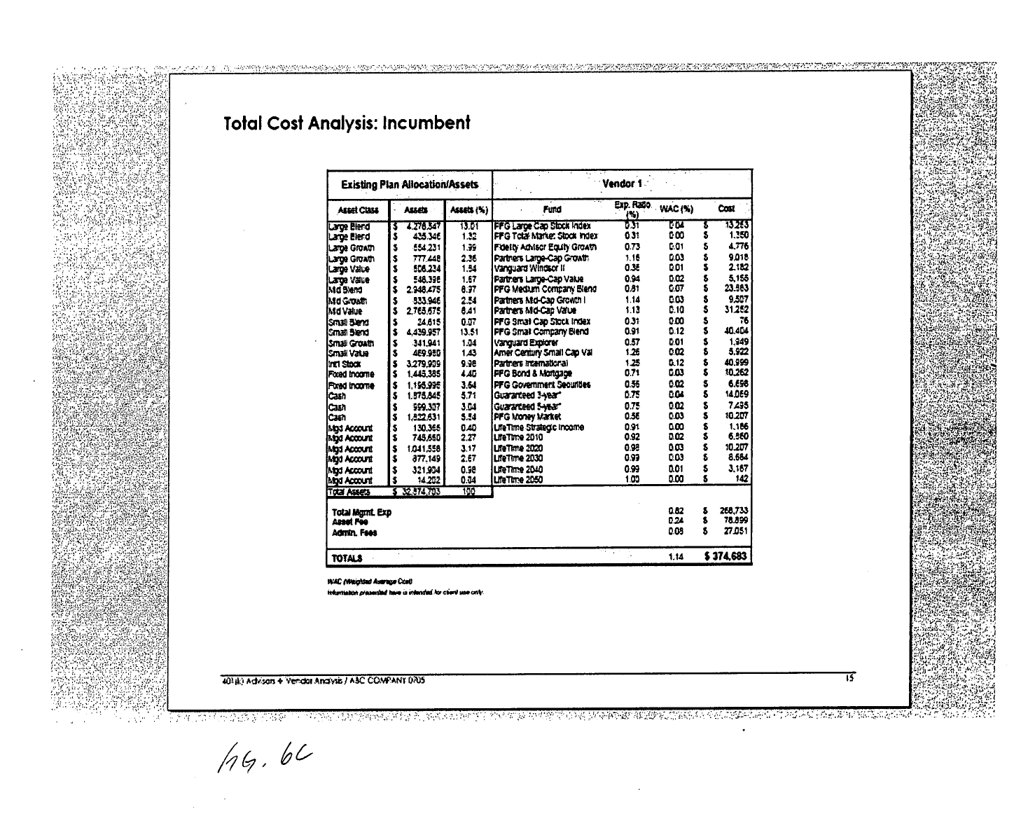

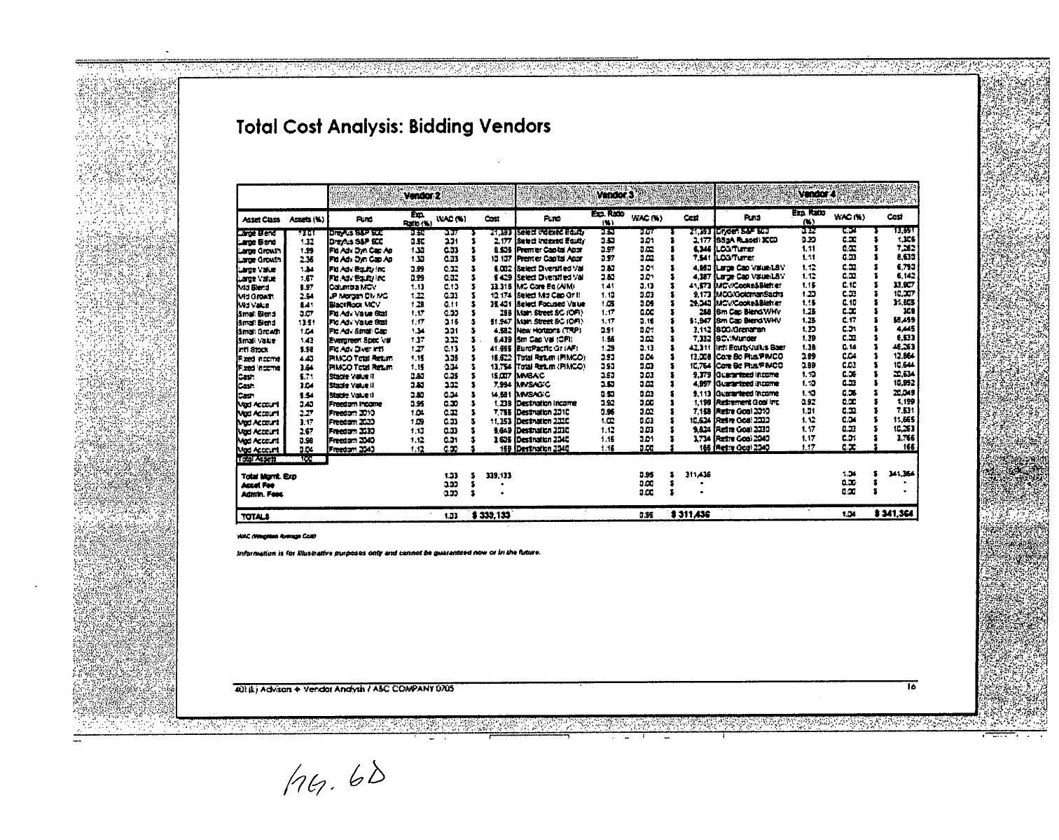

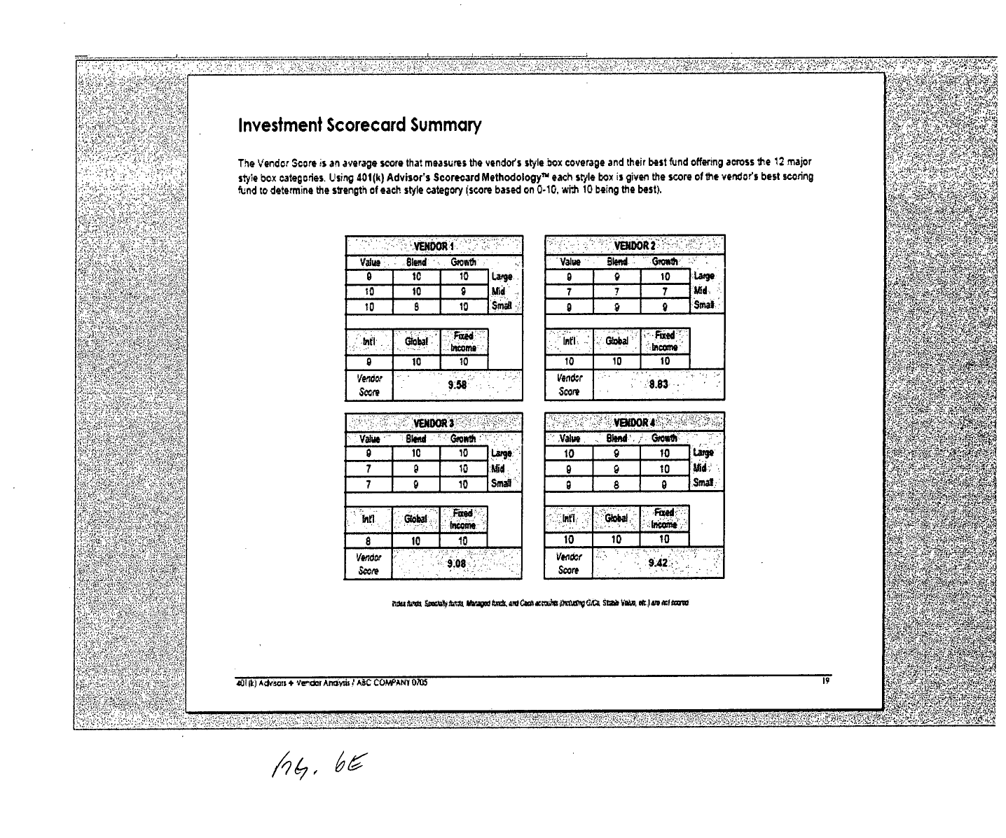

In one embodiment, for example, selecting a RFP and Benchmarking icon 178 invokes a comparison, illustrated in FIGS. 6A-6E, between a current or incumbent plan provider (e.g., Vendor 1) and a number of competing plan providers (e.g., Vendor 2, Vendor 3 and Vendor 4). As shown in FIGS. 6A-6E, core competencies, fees, total costs and a Scorecard^{SM} summary report for the subject vendors is provided to the fiduciaries 14.

It should be appreciated that one or more of the documentary reports provided by the advisor 50 to the fiduciaries 14 (e.g., the reports 110) are available in electronic form through the GUI 150 (e.g., reports 110′ of FIG. 2).

With the aid of the information provided in the deliverable 74 (e.g., the reports 110 and/or the reports 110′ provided via the GUI 150), the fiduciaries 14 and plan sponsor 10 select the product 82 and plan provider 84 to provide a qualified retirement plan and investment services to the plan participants 20. It should be appreciated, however, that the aforementioned evaluation of available products 62 and plan providers 64 does not necessarily end with the selection of the offered qualified retirement plan (e.g., products 82). Rather, there is an on-going evaluation of both the performance of the selected product 82 and plan provider 84 to ensure a “healthy” qualified retirement plan is being offered to the plan participants 20 (e.g., compliant with state, federal and other regulations, as well as providing positive accumulations 34) and of the performance of other products 62 to ensure that another, more desirable plan is not available. For example, in one embodiment, investment due diligence may be performed quarterly, semi-annually or annually, to ensure that investments within the qualified retirement plan are performing in-line with expectations. On the other hand, vendor/plan provider benchmarking may be done as needed, e.g., when a change at the plan sponsor 10 impacts the dynamics of the plan (company merger and/or significant increase in plan assets), or there has been a perceived decrease in the level of service. Generally speaking, plan provider benchmarking is performed every three-five (3-5) years.

As described above, the systems and methods for providing advisory assistance in qualified retirement plan selection and investment due diligence has been from an advisor to fiduciaries of a particular plan sponsor/employer. That is, the systems and methods have been presented as a retail model wherein an advisor (retailer) offers services directly to the fiduciaries (customer). It should be appreciated that it is also within the scope of the present invention to provide the systems and methods as described herein to one or more entities that may provide advisory services to fiduciaries from a wide range of plan sponsors. In other words, it is within the scope of the present invention for the systems and methods described herein to be offered as a suite of services to entities (other retailers) that may, in turn, provide advisory assistance (e.g., assume the advisor 50 role) to fiduciaries (other customers). In this regard, the systems and methods of the present invention are offered as a wholesale model.

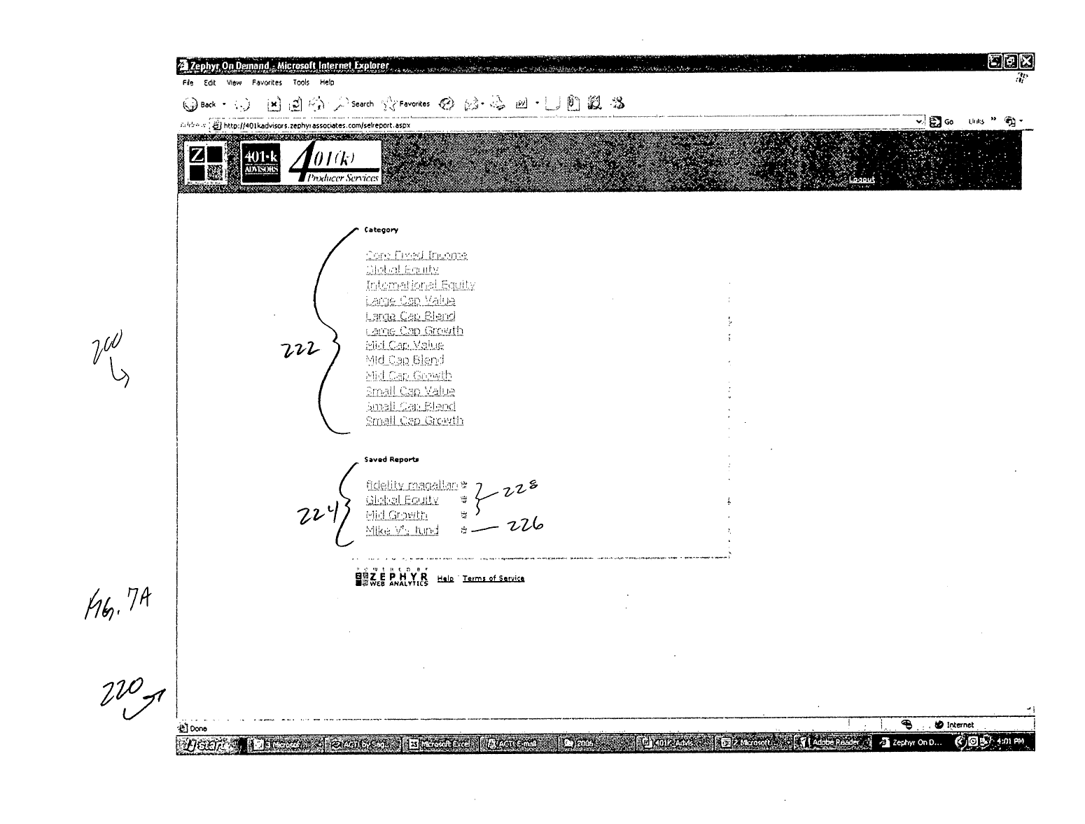

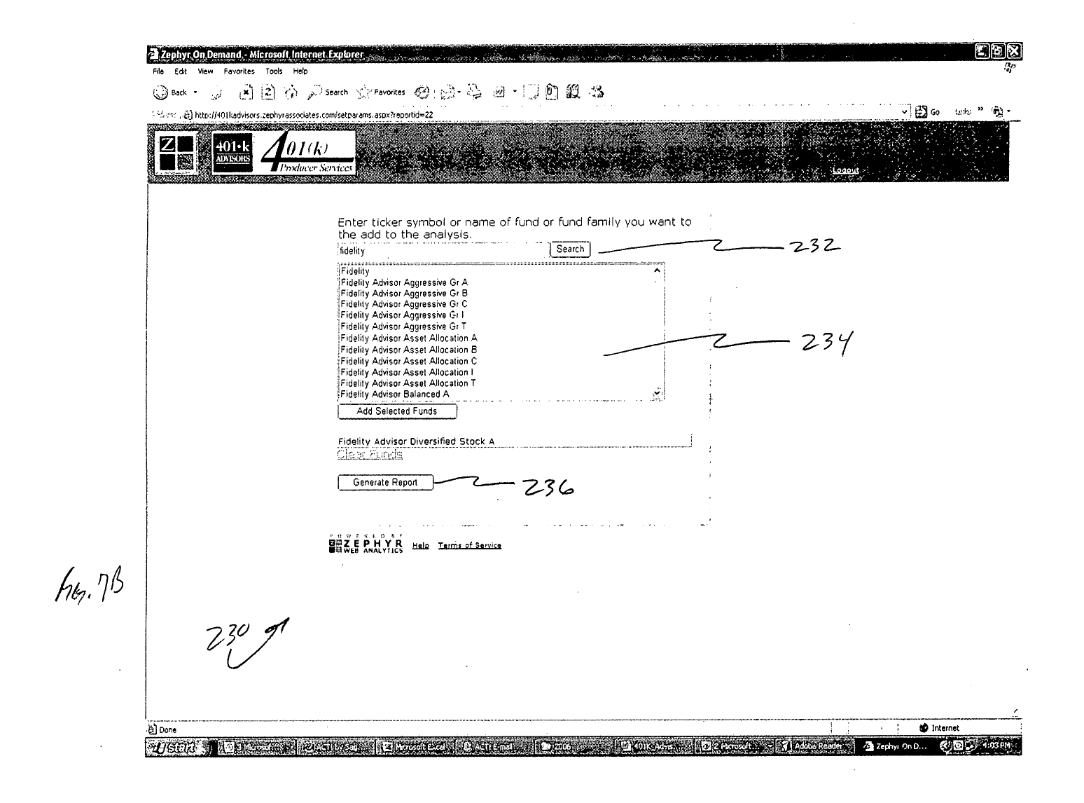

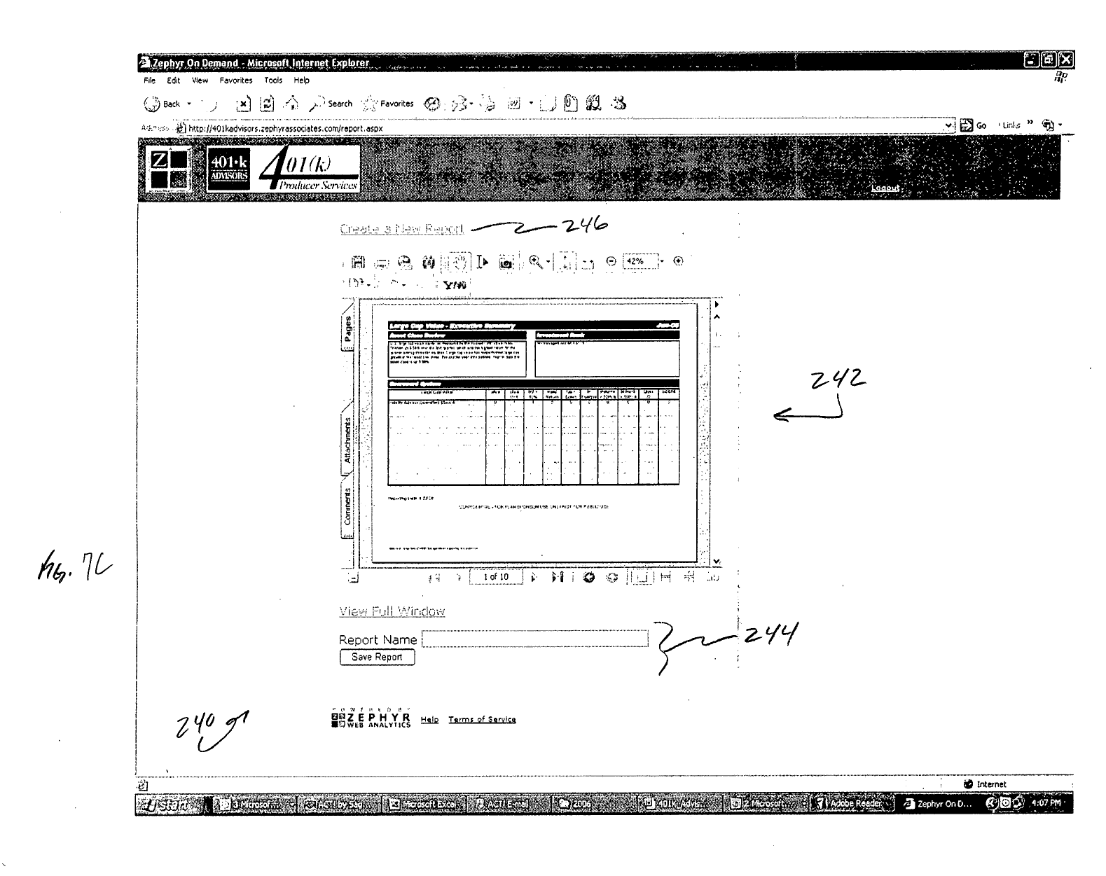

Referring again to FIG. 5A, in one embodiment of the wholesale model, selecting a Producer Services link 156 from within the sub-menu 154 invokes a Producer Services dialogue 200 (FIGS. 7A-7C). In another embodiment, the Producer Services dialogue 200 may be accessed via an independent logon GUI, as is generally known to those in the art. The Producer Services dialogue 200 provides a vehicle by which the advisor 50 invokes a fund analysis (e.g., calculates scores for the fund provided in a customized one of the Scorecard^{SM} Reports 110). For example, the Producer Services dialogue 200 includes a Producer Services GUI 220, depicted in FIG. 7A. In one embodiment, a portion 222 of the Producer Services GUI 220 includes categories of asset classes (e.g., fixed income, global equity, international equity classes and the like) of interest to the advisor 50 and another portion 224 of the Producer Services GUI 220 includes a list of reports that can be selected to provide a current analysis, via a customized Scorecard^{SM} report, of funds previously selected by the advisor 50. In one embodiment, the list of reports 224 includes reports customized by the advisor 50 (e.g., a Mike V's fund report 226) as well as reports of funds in a predetermined asset class (e.g., a Global Equity, Mid-Growth report 228). As illustrated in FIG. 7B, the Producer Services dialogue 200 includes an ability to generate custom reports at GUI 230 by specifying, at input field 232, a fund (e.g., by fund name or stock ticker symbol) or an asset class family. If the advisor 50 enters an asset class family, a list 234 is provided on the GUI 230 of funds within that asset class family. When a fund is selected, e.g., either by entering the fund name or symbol in field 232 or by selected the fund from the list 234, the advisor 50 may generate a customized Scorecard^{SM} report 242 by selecting a Generate Report button 236. The customized Scorecard^{SM} report 242 is provided in a GUI 240 depicted in FIG. 7C. The customized Scorecard^{SM} report 242 can be stored (e.g., saved as one of the previous reports 224 (FIG. 7A)), for later viewing and analysis by naming the reporting and selecting a Save Report button at 244. Alternatively, the advisor 50 may create a new report by selecting link 246, which returns the advisor 50 to the custom reports GUI 230 (FIG. 7B).

One or more embodiments of the present invention have been described. Nevertheless, it will be understood that various modifications may be made without departing from the spirit and scope of the invention. Accordingly, other embodiments are within the scope of the following claims.

What is claimed is:

1. A method for providing advisory assistance from an advisor to a fiduciary for qualified financial plans, the method comprising the steps of:
generating a statement outlining a process for selecting, monitoring and evaluating investment options to determine a desired investment offerings in a qualified financial plan;
evaluating a plurality of products and services within available qualified financial plans offered by a plurality of plan providers, wherein the step of evaluating comprises:
identifying components of each of the plurality of qualified financial plans;
creating reports for each of the plurality of plan provider's investment options based at least on performance, style characteristics and peer group rankings, in accordance with specified criteria, wherein at least one of the reports includes a score for the plurality of plan provider's investment options within their corresponding plans; and
providing the reports to the fiduciary;
reviewing, by the fiduciary, the provided reports and selecting a qualified plan;
monitoring, by the advisor, the performance of the selected plan provider, the investment options within the selected plan and other of the plurality of plan providers and the plurality of products and services offered by the other plan providers; and
providing results of the monitoring, upon request, from the advisor to the fiduciary.

2. The method of claim 1, wherein the statement outlines underlying philosophies and processes for the selecting, monitoring and evaluating by:
defining the plan's investment objectives;
defining roles of those responsible for the plan's investments;
describing criterion and procedures for selecting investment options;
establishing investment procedures, measurement standards and monitoring procedures; and
describing ways to address investment options and investment managers that fail to satisfy established objectives.

3. The method of claim 1, wherein the components of each of the plurality of qualified financial plans includes plan administration, record keeping, plan compliance to regulatory mandates, investment management, technology services, communication to plan participants, and total cost of the plan.

4. The method of claim 1, wherein the score includes a value for each of the plurality of products in a plurality of asset classes within each of the plans offered by the plurality of plan providers.

5. The method of claim 4, wherein the specified criteria provides the score of each of the plurality of products within predetermined quantitative and qualitative factors of the investments within the plurality of products.

6. The method of claim 5, wherein the quantitative factors include style analysis, rolling style analysis, risk/return, R-squared, up/down capture analysis, information ratio, returns peer group ranking, and information ratio peer group ranking.

7. The method of claim 5, wherein the qualitative factors include manager tenure, asset expenses, strength/significance of statistics, quality of firm, resources and reputation, pending litigation, legal and governance issues, other factors impacting the asset's management.

8. The method of claim 4, wherein the score for each of the plurality of plan providers is an average score that measures the plan provider's style box coverage and best asset class offering across multiple style box categories.

9. The method of claim 1, wherein the evaluation for each of the plurality of plan providers includes a plan provider analysis to ensure financial strength and future market commitment, an evaluation of product and services capabilities to gage an ability to deliver excellence with all plan components, an evaluation of delivery system compatibility to ensure that the delivery of provider services fit plan sponsor and plan participant needs, and demographical compatibility to ensure a plan provider is committed to plans like those needed by the plan sponsor.

10. The method of claim 9, wherein the investment opportunities and product components are balanced with the total cost to the plan sponsor and/or plan participants so that the optimal retirement plan can be selected, assembled and monitored.

11. The method of claim 1, wherein the step of providing reports includes communicating at least one of unusual, notable, and extraordinary events regarding the selected plan provider to the fiduciaries.

12. The method of claim 1, wherein the step of reviewing, by the fiduciary the provided reports are provided in at least one of documentary form and electronic form via an interactive graphical user interface.

13. A method for providing advisory assistance from an advisor to a fiduciary for financial plans, the method comprising the steps of:
evaluating a plurality of products and services within available financial plans offered by a plurality of plan providers, wherein the step of evaluating comprises:
identifying components of each of the plurality of financial plans;
creating reports for each of the plurality of plan provider's investment options based at least on performance, style characteristics and peer group rankings, in accordance with specified criteria, wherein at least one of the reports includes a score for the plurality of plan provider's investment options within their corresponding plans; and
providing the reports to the fiduciary;
reviewing, by the fiduciary, the provided reports and selecting a plan;
monitoring, by the advisor, the performance of the selected plan provider, the investment options within the selected plan and other of the plurality of plan providers and the plurality of products and services offered by the other plan providers; and
providing results of the monitoring, upon request, from the advisor to the fiduciary.

14. The method of claim 13, wherein the score of each of the plurality of products measures specific quantitative and qualitative factors of the investments within the plurality of products.

15. The method of claim 14, wherein the quantitative factors include style analysis, rolling style analysis, risk/return, R-squared, up/down capture analysis, information ratio, returns peer group ranking, and information ratio peer group ranking.

16. The method of claim 14, wherein the qualitative factors include manager tenure, asset expenses, strength/significance of statistics, quality of firm, resources and reputation, pending litigation, legal and governance issues, other factors impacting the asset's management.
